(19) United States
(12) Patent Application Publication
(10) Pub. No.: US 2017/0058062 A1
(43) Pub. Date: Mar. 2, 2017

(54) USE OF PARTICULAR POLYMERS AS CHARGE STORAGE MEANS

(71) Applicants: Ulrich SCHUBERT, Jena (DE); Andreas WILD, Weimar (DE); Bernhard HAEUPLER, Erlangen (DE)

(72) Inventors: Ulrich SCHUBERT, Jena (DE); Andreas WILD, Weimar (DE); Bernhard HAEUPLER, Erlangen (DE)

(73) Assignee: Evonik Degussa GmbH, Essen (DE)

(21) Appl. No.: 15/247,434

(22) Filed: Aug. 25, 2016

(30) Foreign Application Priority Data
Aug. 26, 2015 (EP) 15182453

(51) Int. Cl. C08F 138/00; H01M 4/66; H01M 4/04; C08F 120/68; H01M 4/60

(52) U.S. Cl. CPC C08F 138/00; C08F 120/68; H01M 4/606; H01M 4/0409; H01M 4/661

(57) ABSTRACT

The present invention relates to polymers and to the use thereof in the form of active electrode material or in an electrode slurry as electrical charge storage means, the electrical charge storage means especially being secondary batteries. The secondary batteries are especially notable for high cell voltages, even when undergoing several charging and discharging cycles, and simple and scalable processing and production methods (for example by means of screen printing).

### BACKGROUND OF THE INVENTION

Field of the Invention

The present invention relates to polymers and to the use thereof in the form of active electrode material or in an electrode slurry as electrical charge storage means, the electrical charge storage means especially being secondary batteries. The secondary batteries are especially notable for high cell voltages, a small drop in capacity even after undergoing several charging and discharging cycles, high power densities and simple and scalable processing and production methods (for example by means of screen printing).

Discussion of the Background

Organic batteries are electrochemical cells which use an organic charge storage material as active electrode material for storing electrical charge. These secondary batteries are notable for their exceptional properties, such as fast chargeability, long lifetime, low weight, high flexibility and ease of processibility. Active electrode materials which have been described for charge storage in the prior art are various polymeric structures, for example polymeric compounds having organic nitroxide radicals as active units (for example in WO 2012133202 A1, WO 2012133204 A1, WO 2012120929 A1, WO 2012153866 A1, WO 2012153865 A1, JP 2012-221574 A, JP 2012-221575 A, JP 2012-219109 A, JP 2012-079639 A, WO 2012029556 A1, WO 2012153865 A1, JP 2011-252106 A, JP 2011-074317 A, JP 2011-165433 A, WO 2011034117 A1, WO 2010140512 A1, WO 2010104002 A1, JP 2010-238403 A, JP 2010-163551 A, JP 2010-114042 A, WO 2010002002 A1, WO 2009038125 A1, JP 2009-298873 A, WO 2004077593 A1, WO 2009145225 A1, JP 2009-238612 A, JP 2009-230951 A, JP 2009-205918 A, JP 2008-234909 A, JP 2008-218326 A, WO 2008099557 A1, WO 2007141913 A1, US 20020041995 A1, EP 1128453 A2, A. Vlad, J. Rolland, G. Hauffman, B. Ernould, J.-F. Gohy, ChemSusChem 2015, 8, 1692-1696) or polymeric compounds having organic phenoxyl radicals or galvinoxyl radicals as active units (for example US 2002/0041995 A1, JP 2002-117852 A).

Other known active units for charge storage are polymeric compounds having quinones (for example JP 2009-217992 A, WO 2013/099567 A1, WO 2011/068217 A1), having diones (for example JP 2010-212152 A), and having dicyanodiimines (for example JP 2012-190545 A, JP 2010-55923 A).

Polymers including dialkoxybenzene have also been described in the prior art for a multitude of different applications. These include the use thereof as epoxy resins for seething of semiconductor modules (for example described in JP 2013098217 A, JP 2012224758 A, JP 2011231153 A, JP 2011138037 A, JP 2010282154 A, JP 2010266556 A, JP 2010077303 A, JP 2008296436 A or WO 2004098745 A1). In addition, dialkoxybenzene-containing non-polymeric compounds have been used as “redox shuttle” additives for Li ion batteries, in order to prevent overcharging of the Li ion battery (WO 2011/149970 A2). In addition, the use of particular polymers based on dialkoxybenzenes as electrical charge storage means has also been described (P. Nesvadba, L. B. Folger, P. Maire, P. Novak, Synth. Met. 2011, 161, 259-262, abbreviated hereinafter to “Nesvadba et al.”; W. Weng, Z. C. Zhang, A. Abouimrane, P. C. Redfern, L. A. Curtiss, K. Amine, Adv. Funct. Mater. 2012, 22, 4485-4492, abbreviated hereinafter to “Weng et al.”). However, these polymers described by Nesvadba et al. and Weng et al. have several disadvantages. Although these have a redox potential above that of the frequently used nitroxide radicals and hence enable higher cell voltages when the dialkoxybenzene-containing polymers are used as cathode material, batteries which have been produced with these polymers described in the literature exhibit only low discharge capacities.

### SUMMARY OF THE INVENTION

It is thus desirable, and therefore is a problem addressed by the invention, to provide polymers with which an even higher cell voltage, higher capacity and hence higher specific energy can be achieved. In addition, synthesis complexity is a further criterion for the usability of organic materials as active electrode materials. A further problem addressed by the present invention was therefore that of providing polymers that can be synthesized in a very simple manner.

Surprisingly, polymers which solve the problems mentioned in the present document have been found. 1. The present invention accordingly relates to a polymer comprising n¹ mutually linked repeat units of the chemical structure (I) or n² mutually linked repeat units of the chemical structure (II) with

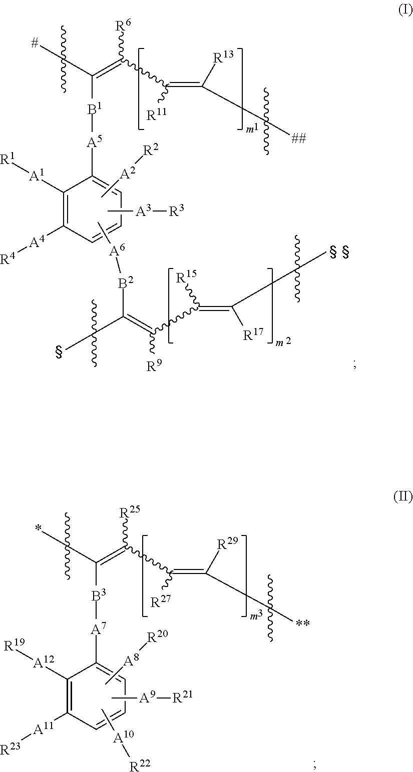

where n¹ and n² are each independently an integer ≧4,

where m¹, m², m³ are each independently an integer ≧0,

where the repeat units of the chemical structure (I) within the polymer are the same or at least partly different from one another,

where the repeat units of the chemical structure (II) within the polymer are the same or at least partly different from one another,

where the repeat units of the chemical structure (I) within the polymer are joined to one another in such a way that the bond identified by “# #” in a particular repeat unit is joined by the bond identified by “#” in the adjacent repeat unit and the bond identified by “§§” in a particular repeat unit is joined by the bond identified by “§” in the adjacent repeat unit,

where the repeat units of the chemical structure (II) within the polymer are joined to one another in such a way that the bond identified by “*” in a particular repeat unit is joined by the bond identified by “**” in the adjacent repeat unit,

where the R¹, R², R³, R⁴, R⁶, R⁹, R¹¹, R¹³, R¹⁵, R¹⁷, R¹⁹, R²⁰, R²¹, R²², R²³, R²⁵, R²⁷, R²⁹ radicals are each independently selected from the group consisting of
hydrogen, (hetero)aromatic radical, aliphatic radical optionally substituted by at least one group selected from nitro group, —NH₂, —CN, —SH, —OH, halogen and optionally having at least one group selected from ether, thioether, amino ether, carbonyl group, carboxylic ester group, carboxamide group, sulphonic ester group, phosphoric ester,

where at least two of A¹, A², A³, A⁴, A⁵, A⁶ are each an oxygen or 4ulphur atom and the others of A¹, A², A³, A⁴, A⁵, A⁶ are each a direct bond,

where at least two of A⁷, A⁸, A⁹, A¹⁰, A¹¹, A¹² are each an oxygen or 4ulphur atom and the others of A⁷, A⁸, A⁹, A¹⁰, A¹¹, A¹² are each a direct bond,

and where at least two radicals in ortho positions to one another among the R¹, R², R³, R⁴ radicals and/or at least two radicals in ortho positions to one another among the R¹⁹, R²⁰, R²¹, R²², R²³ radicals may each also be bridged by at least one (hetero)aromatic ring or aliphatic ring optionally substituted by at least one group selected from nitro group, —NH₂, —CN, —SH, —OH, halogen, alkyl group and optionally having at least one group selected from ether, thioether, amino ether, carbonyl group, carboxylic ester group, carboxamide group, sulphonic ester group, phosphoric ester,

and where the R¹ radical in the case that A¹=direct bond, the R² radical in the case that A²=direct bond, the R³ radical in the case that A³=direct bond, the R⁴ radical in the case that A⁴=direct bond, the R¹⁹ radical in the case that A¹²=direct bond, the R²⁰ radical in the case that A⁸=direct bond, the R²¹ radical in the case that A⁹=direct bond, the R²² radical in the case that A¹⁰=direct bond, the R²³ radical in the case that A¹¹=direct bond and the R⁶, R⁹, R¹¹, R¹³, R¹⁵, R¹⁷, R²⁵, R²⁷, R²⁹ radicals may each also be selected from the group consisting of
nitro group, —CN, —F, —Cl, —Br, —I, —COOR³⁶, —C(═O)NHR³⁷, —NR³⁸R³⁹, where R³⁶, R³⁷, R³⁸, R³⁹ are each independently selected from the group consisting of hydrogen, (hetero)aromatic radical, aliphatic radical optionally substituted by at least one group selected from nitro group, —NH₂, —CN, —SH, —OH, halogen and optionally having at least one group selected from ether, thioether, amino ether, carbonyl group, carboxylic ester group, carboxamide group, sulphonic ester group, phosphoric ester,

and where the R⁶, R⁹, R¹¹, R¹³, R¹⁵, R¹⁷, R²⁵, R²⁷, R²⁹ radicals may independently also be a radical of the formula —O—R⁴⁰ where R⁴⁰ is an aliphatic radical optionally substituted by at least one group selected from nitro group, —NH₂, —CN, —SH, —OH, halogen and optionally having at least one group selected from ether, thioether, amino ether, carbonyl group, carboxylic ester group, carboxamide group, sulphonic ester group, phosphoric ester,

where B¹, in the case that A⁵=O or S, B² in the case that A⁶=O or S, B³ in the case that A⁷=O or S, are each independently selected from the group consisting of
direct bond,

&-(X¹)ₚ₁—[C═X²]ₚ₂—(X³)ₚ₃—B⁵—(Y²)_{q2}—[C═Y¹]_{q1}-&&,

&-(Y³)_{q3}—(C═Y⁴)-&&,

and where B¹, in the case that A⁵=direct bond, B² in the case that A⁶=direct bond, B³ in the case that A⁷=direct bond, are independently selected from the group consisting of

&-(X⁴)ₚ₄—[C═X⁵]ₚ₅—(X⁶)ₚ₆—B⁶—(Y⁷)_{q6}—[C═Y⁶]_{q5}—(Y⁵)_{q4}-&&,

&-(Y¹⁰)_{q9}—(C═Y⁹)_{q8}—(Y⁸)_{q7}-&&,
where p1, p2, p3 are each 0 or 1, with the proviso that it is not simultaneously true that p1=p3=1 and p2=0,
where p4, p5, p6 are each 0 or 1, with the proviso that it is not simultaneously true that p4=p6=1 and p5=0,
where q1, q2 are each 0 or 1, where, when q1=0, then q2=0, where q3=0 or 1,
where q4, q5, q6 are each 0 or 1, with the proviso that it is not simultaneously true that q4=q6=1 and q5=0,
where q7, q8, q9 are each 0 or 1, with the proviso that it is not simultaneously true that q7=q9=1 and q8=0, and that, when q7=1 and q8=0, then q9=0,
where X², X⁵, Y¹, Y⁴, Y⁶, Y⁹ are independently selected from the group consisting of oxygen, 5ulphur,
where X¹, X³, X⁴, X⁶, Y², Y³, Y⁷, Y¹⁰ are independently selected from the group consisting of O, S, NH, N-alkyl,
where Y⁵, Y⁸ is selected from NH, N-alkyl,
where B⁵, B⁶ are independently selected from the group consisting of
divalent (hetero)aromatic radical,
divalent aliphatic radical optionally substituted by at least one group selected from nitro group, —NH₂, —CN, —SH, —OH, halogen and optionally having at least one group selected from ether, thioether, amino ether, carbonyl group, carboxylic ester group, carboxamide group, sulphonic ester group, phosphoric ester,

and where “&&” for B′ denotes the bond pointing toward A⁵, for B² the bond pointing toward A⁶, and for B³ the bond pointing toward A⁷,

and where “&” for B′ denotes the bond which joins B′ to the double bond, for B² the bond which joins B² to the double bond, and for B³ the bond which joins B³ to the double bond.

### DETAILED DESCRIPTION OF THE INVENTION

The polymer according to the invention as per point 1 may especially comprise n′ mutually linked repeat units of the chemical structure (I) with the above-specified definitions of R¹, R², R³, R⁴, R⁶, R⁹, R¹¹, R¹³, R¹⁵, R¹⁷, A¹ to A⁶, B¹, B², m¹, m².

The polymer according to the invention as per point 1 may alternatively especially comprise n² mutually linked repeat units of the chemical structure (II) with the above-specified definitions of R¹⁹, R²⁰, R²¹, R²², R²³, R²⁵, R²⁷, R²⁹, A⁷ to A¹², B³, m³.

2. More particularly, the present invention relates to a polymer comprising n¹ mutually linked repeat units of the chemical structure (I) or n² mutually linked repeat units of the chemical structure (II) with

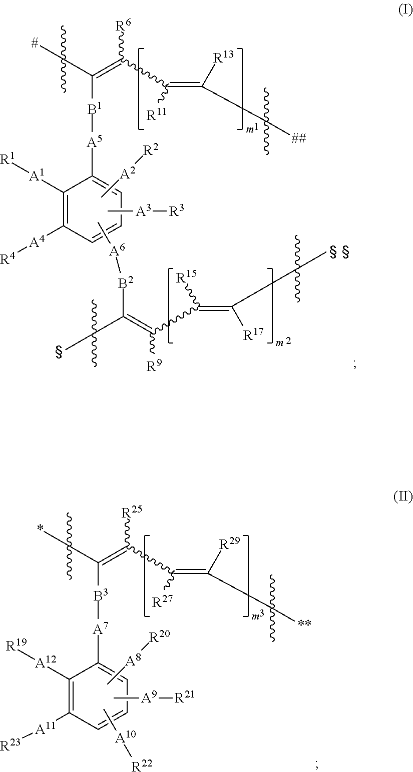

where n¹ and n² are each independently an integer ≧4, especially ≧4 and ≦5000,

where m¹, m², m³ are each independently an integer ≧0, especially ≧0 and ≦5000,

where the repeat units of the chemical structure (I) within the polymer are the same or at least partly different from one another,

where the repeat units of the chemical structure (II) within the polymer are the same or at least partly different from one another,

where the repeat units of the chemical structure (I) within the polymer are joined to one another in such a way that the bond identified by “# #” in a particular repeat unit is joined by the bond identified by “#” in the adjacent repeat unit and the bond identified by “§§” in a particular repeat unit is joined by the bond identified by “§” in the adjacent repeat unit,

where the repeat units of the chemical structure (II) within the polymer are joined to one another in such a way that the bond identified by “*” in a particular repeat unit is joined by the bond identified by “**” in the adjacent repeat unit,

where the R¹, R², R³, R⁴, R⁶, R⁹, R¹¹, R¹³, R¹⁵, R¹⁷, R¹⁹, R²⁰, R²¹, R²², R²³, R²⁵, R²⁷, R²⁹ radicals are each independently selected from the group consisting of
hydrogen, phenyl, benzyl,
aliphatic radical optionally substituted by at least one group selected from nitro group, —NH₂, —CN, —SH, —OH, halogen and optionally having at least one group selected from ether, thioether, amino ether, carbonyl group, carboxylic ester group, carboxamide group, sulphonic ester group, phosphoric ester, and especially from the group consisting of hydrogen, alkyl group having 1 to 30 carbon atoms,

and where the R¹¹, R¹³, R¹⁵, R¹⁷ radicals may each independently also be a group of the general structure (III) with

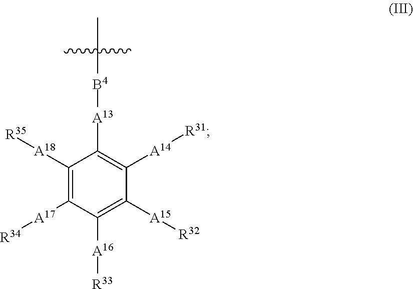

in which the R³¹, R³², R³³, R³⁴, R³⁵ radicals may independently be as defined for R¹ and are especially each independently an alkyl group having 1 to 30 carbon atoms,

where at least two, preferably exactly two, of A¹, A², A³, A⁴, A⁵, A⁶ are each an oxygen or 7anofib atom, especially an oxygen atom, and the others of A′, A2, A3, A4, As, A6 are each a direct bond,

where at least two, preferably exactly two, of A⁷, A⁸, A⁹, A¹¹, A¹¹, A¹² are each an oxygen or 7anofib atom, especially an oxygen atom, and the others of A⁷, A⁸, A⁹, A¹⁰, A¹¹, A¹² are each a direct bond,

where at least two, preferably exactly two, of A¹³, A¹⁴, A¹⁵, A¹⁶, A¹⁷, A¹⁸ are each an oxygen or 8anofib atom, especially an oxygen atom, and the others of A¹³, A¹⁴, A¹⁵, A¹⁶, A¹⁷, A¹⁸ are each a direct bond,

and where at least two radicals in ortho positions to one another among the R¹, R², R³, R⁴ radicals and/or at least two radicals in ortho positions to one another among the R¹⁹, R²⁰, R²¹, R²², R²³ radicals and/or at least two radicals in ortho positions to one another among the R³¹, R³², R³³, R³⁴, R³⁵ radicals may each also be bridged by at least one (hetero)aromatic ring or aliphatic ring optionally substituted by at least one group selected from nitro group, —NH₂, —CN, —SH, —OH, halogen, alkyl group and optionally having at least one group selected from ether, thioether, amino ether, carbonyl group, carboxylic ester group, carboxamide group, sulphonic ester group, phosphoric ester,

and where the R¹ radical in the case that A¹=direct bond, the R² radical in the case that A²=direct bond, the R³ radical in the case that A³=direct bond, the R⁴ radical in the case that A⁴=direct bond, the R¹⁹ radical in the case that A¹²=direct bond, the R²⁰ radical in the case that A⁸=direct bond, the R²¹ radical in the case that A⁹=direct bond, the R²² radical in the case that A¹⁰=direct bond, the R²³ radical in the case that A¹¹=direct bond, the R³¹ radical in the case that A¹⁴=direct bond, the R³² radical in the case that A¹⁵=direct bond, the R³³ radical in the case that A¹⁶=direct bond, the R³⁴ radical in the case that A¹⁷=direct bond, the R³⁵ radical in the case that A¹⁸=direct bond and the R⁶, R⁹, R¹³, R¹⁵, R¹⁷, R²⁵, R²⁷, R²⁹ radicals may each also be selected from the group consisting of
nitro group, —CN, —F, —Cl, —Br, —I, —COOR³⁶, —C(═O)NHR³⁷, —NR³⁸R³⁹, where R³⁶, R³⁷, R³⁸, R³⁹ are each independently selected from the group consisting of hydrogen, (hetero)aromatic radical, aliphatic radical optionally substituted by at least one group selected from nitro group, —NH₂, —CN, —SH, —OH, halogen and optionally having at least one group selected from ether, thioether, amino ether, carbonyl group, carboxylic ester group, carboxamide group, sulphonic ester group, phosphoric ester,

and where the R⁶, R⁹, R¹¹, R¹³, R¹⁵, R¹⁷, R²⁵, R²⁷, R²⁹ radicals may independently also be a radical of the formula —O—R⁴⁰ where R⁴⁰ is an aliphatic radical optionally substituted by at least one group selected from nitro group, —NH₂, —CN, —SH, —OH, halogen and optionally having at least one group selected from ether, thioether, amino ether, carbonyl group, carboxylic ester group, carboxamide group, sulphonic ester group, phosphoric ester,

where B¹, in the case that A⁵=O or S, B² in the case that A⁶=O or S, B³ in the case that A⁷=O or S, B⁴ in the case that A¹³=O or S, are independently selected from the group consisting of
direct bond,

&-(X¹)ₚ₁—[C═X²]ₚ₂—(X³)ₚ₃—B⁵—(Y²)_{q2}—[C═Y¹]_{q1}-&&,

&-(Y³)_{q3}—(C═Y⁴)-&&,

and where B¹, in the case that A⁵=direct bond, B² in the case that A⁶=direct bond, B³ in the case that A⁷=direct bond, B⁴ in the case that A¹³=direct bond, are independently selected from the group consisting of

&-(X⁴)ₚ₄—[C═X⁵]ₚ₅—(X⁶)ₚ₆—B⁶—(Y⁷)_{q6}—[C═Y⁶]_{q5}—(Y⁵)_{q4}-&&,

&-(Y¹⁰)_{q9}—(C═Y⁹)_{q8}—(Y⁸)_{q7}-&&,
where p1, p2, p3 are each 0 or 1, with the proviso that it is not simultaneously true that p1=p3=1 and p2=0,
where p4, p5, p6 are each 0 or 1, with the proviso that it is not simultaneously true that p4=p6=1 and p5=0,
where q1, q2 are each 0 or 1, where, when q1=0, then q2=0,
where q3=0 or 1,
where q4, q5, q6 are each 0 or 1, with the proviso that it is not simultaneously true that q4=q6=1 and q5=0,
where q7, q8, q9 are each 0 or 1, with the proviso that it is not simultaneously true that q7=q9=1 and q8=0, and that, when q7=1 and q8=0, then q9=0,
where X², X⁵, Y¹, Y⁴, Y⁶, Y⁹ are independently selected from the group consisting of oxygen, 9anofib,
where X¹, X³, X⁴, X⁶, Y², Y³, Y⁷, Y¹⁰ are independently selected from the group consisting of O, S, NH, N-alkyl, where the alkyl group especially has 1 to 10 carbon atoms,
where Y⁵, Y⁸ is selected from NH, N-alkyl, where the alkyl group especially has 1 to 10 carbon atoms,
where B⁵, B⁶ are independently selected from the group consisting of
divalent (hetero)aromatic radical,
divalent aliphatic radical optionally substituted by at least one group selected from nitro group, —NH₂, —CN, —SH, —OH, halogen and optionally having at least one group selected from ether, thioether, amino ether, carbonyl group, carboxylic ester group, carboxamide group, sulphonic ester group, phosphoric ester, and where especially B⁵, B⁶ are each independently a divalent aliphatic radical optionally having at least one group selected from ether, thioether, amino ether,

and where “&&” for B¹ denotes the bond pointing toward A⁵, for B² the bond pointing toward A⁶, for B³ the bond pointing toward A⁷, and for B⁴ the bond pointing toward A¹³,

and where “&” for B¹ denotes the bond which joins B¹ to the double bond, for B² the bond which joins B² to the double bond, for B³ the bond which joins B³ to the double bond, and for B⁴ the bond which joins B⁴ to the double bond.

The polymer according to the invention as per point 2 may especially comprise n¹ mutually linked repeat units of the chemical structure (I) with the above-specified definitions of R¹, R², R³, R⁴, R⁶, R⁹, R¹¹, R¹³, R¹⁵, R¹⁷, A¹ to A⁶, B¹, B², m¹, m².

The polymer according to the invention as per point 2 may alternatively especially comprise n² mutually linked repeat units of the chemical structure (II) with the above-specified definitions of R¹⁹, R²⁰, R²¹, R²², R²³, R²⁵, R²⁷, R²⁹, A⁷ to A¹², B³, m³.

3. In a preferred embodiment, the present invention relates to a polymer comprising n¹ mutually linked repeat units of the chemical structure (I) or n² mutually linked repeat units of the chemical structure (II) with

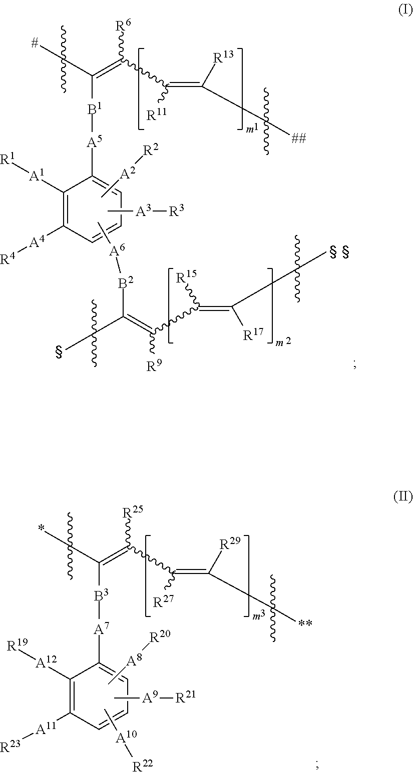

where n¹ and n² are each independently an integer ≧4 and ≦5000, especially ≧10 and ≦1000,

where m¹, m², M³ are each independently an integer ≧0 and ≦5000, especially ≧0 and ≦1000,

where the repeat units of the chemical structure (I) within the polymer are the same or at least partly different from one another,

where the repeat units of the chemical structure (II) within the polymer are the same or at least partly different from one another,

where the repeat units of the chemical structure (I) within the polymer are joined to one another in such a way that the bond identified by “# #” in a particular repeat unit is joined by the bond identified by “#” in the adjacent repeat unit and the bond identified by “§§” in a particular repeat unit is joined by the bond identified by “§” in the adjacent repeat unit,

where the repeat units of the chemical structure (II) within the polymer are joined to one another in such a way that the bond identified by “*” in a particular repeat unit is joined by the bond identified by “**” in the adjacent repeat unit,

where the R¹, R², R³, R⁴, R⁶, R⁹, R¹¹, R¹³, R¹⁵, R¹⁷, R¹⁹, R²⁰, R²¹, R²³, R²⁵, R²⁷, R²⁹ radicals are each independently selected from the group consisting of
hydrogen, alkyl group having 1 to 30 and especially 1 to 8 carbon atoms, and where R²² is an alkyl group having 1 to 30 and especially 1 to 8 carbon atoms,

and where the R¹¹, R¹³, R¹⁵, R¹⁷ radicals may each independently also be a group of the general structure (III) with

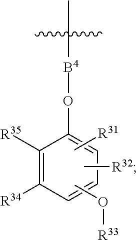

(III)
where the R³¹, R³², R³⁴, R³⁵ radicals are each independently selected from the group consisting of
hydrogen, alkyl group having 1 to 30 and especially 1 to 8 carbon atoms,
and where R³³ is an alkyl group having 1 to 30 and especially 1 to 8 carbon atoms,

and where the R⁶, R⁹, R¹¹, R¹³, R¹⁵, R¹⁷, R²⁵, R²⁷, R²⁹ radicals may each also be selected from the group consisting of
nitro group, —CN, —F, —Cl, —Br, —I, —O—R⁴⁰ where R⁴⁰ is an alkyl group having 1 to 30 and especially 1 to 8 carbon atoms,

where B¹, B², B³, B⁴ are independently selected from the group consisting of direct bond,

&-(X¹)ₚ₁—[C═X²]ₚ₂—(X³)ₚ₃—B⁵—(Y²)_{q2}—[C═Y¹]_{q1}-&&

&-(Y³)_{q3}—(C═Y⁴)-&&,

especially from the group consisting of
direct bond,

&-(O)ₚ₁—[C═O]ₚ₂—(O)ₚ₃—B⁵-&&,
where p1, p2, p3 are each 0 or 1, with the proviso that it is not simultaneously true that p1=p3=1 and p2=0,
where q1, q2 are each 0 or 1, where, when q1=0, then q2=0,
where q3=0 or 1,
where X², Y¹, Y⁴ are independently selected from the group consisting of oxygen, 12anofib, and especially X²═Y¹═Y⁴═O,
where X¹, X³, Y², Y³ are independently selected from the group consisting of O, S, and especially X¹═X³═Y²═Y³═O,
and where B⁵ is selected from the group consisting of & phenylene-CH₂-&&, a divalent aliphatic radical optionally having at least one group selected from ether, thioether, amino ether, especially an alkylene group even more preferably having 1 to 30 carbon atoms,

and where “&&” for B¹ denotes the bond pointing toward A⁵=oxygen, for B² the bond pointing toward A⁶=oxygen, for B³ the bond pointing toward A⁷=oxygen, and for B⁴ the bond pointing toward A¹³=oxygen,

and where “&” for B¹ denotes the bond which joins B¹ to the double bond, for B² the bond which joins B² to the double bond, for B³ the bond which joins B³ to the double bond, and for B⁴ the bond which joins B⁴ to the double bond.

The polymer according to the invention as per point 3 may especially comprise n¹ mutually linked repeat units of the chemical structure (I) with the above-specified definitions of R¹, R², R³, R⁴, R⁶, R⁹, R¹¹, R¹³, R¹⁵, R¹⁷, B¹, B², m¹, m².

The polymer according to the invention as per point 1 may alternatively especially comprise n² mutually linked repeat units of the chemical structure (II) with the above-specified definitions of R¹⁹, R²⁰, R²¹, R²², R²³, R²⁵, R²⁷, R²⁹, B³, m³.

4. In a more preferred embodiment, the present invention relates to a polymer comprising n¹ mutually linked repeat units of the chemical structure (I) or n² mutually linked repeat units of the chemical structure (II) with

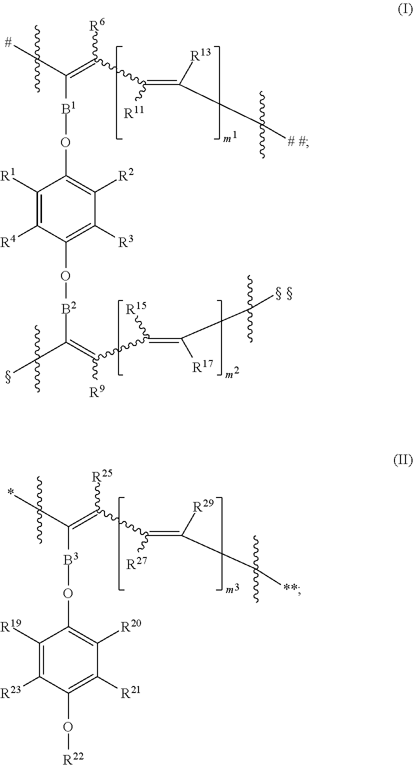

where n¹ and n² are each independently an integer ≧10 and ≦1000,

where m¹, m², m³ are each independently an integer ≧0 and ≦1000,

where the repeat units of the chemical structure (I) within the polymer are the same or at least partly different from one another,

where the repeat units of the chemical structure (II) within the polymer are the same or at least partly different from one another,

where the repeat units of the chemical structure (I) within the polymer are joined to one another in such a way that the bond identified by “# #” in a particular repeat unit is joined by the bond identified by “#” in the adjacent repeat unit and the bond identified by “§§” in a particular repeat unit is joined by the bond identified by “§” in the adjacent repeat unit,

where the repeat units of the chemical structure (II) within the polymer are joined to one another in such a way that the bond identified by “*” in a particular repeat unit is joined by the bond identified by “**” in the adjacent repeat unit,

where the R¹, R², R³, R⁴, R⁶, R⁹, R¹¹, R¹³, R¹⁵, R¹⁷, R¹⁹, R²⁰, R²¹, R²³, R²⁵, R²⁷, R²⁹ radicals are each independently selected from the group consisting of hydrogen, alkyl group having 1 to 8 carbon atoms,

and where R²² is an alkyl group having 1 to 8 carbon atoms,

and where the R¹¹, R¹³, R¹⁵, R¹⁷ radicals may each independently also be a group of the general structure (III) with

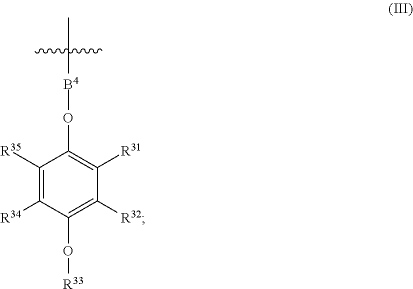

where the R³¹, R³², R³⁴, R³⁵ radicals are each independently selected from the group consisting of hydrogen, alkyl group having 1 to 8 carbon atoms,

and where R³³ is an alkyl group having 1 to 8 carbon atoms,

and where R⁶, R⁹, R¹¹, R¹³, R¹⁵, R¹⁷, R²⁵, R²⁷, R²⁹ may each also be selected from the group consisting of
nitro group, —CN, —F, —Cl, —Br, —I, —O—R⁴⁰ where R⁴⁰ is an alkyl group having 1 to 8 carbon atoms,
where B¹, B², B³, B⁴ are independently selected from the group consisting of direct bond,

&-(O)ₚ₁—[C═O]ₚ₂—(O)ₚ₃—B⁵-&&,
where p1, p2, p3 are each 0 or 1, with the proviso that it is not simultaneously true that p1=p3=1 and p2=0,
B⁵=alkylene group having 1 to 30 carbon atoms; even more preferably, p1=p2=p3=0 and B⁵=alkylene group having 1 to 10 carbon atoms,

and where “&&” for B¹ denotes the bond pointing toward A⁵=oxygen, for B² the bond pointing toward A⁶=oxygen, for B³ the bond pointing toward A⁷=oxygen, and for B⁴ the bond pointing toward A¹³=oxygen,

and where “&” for B¹ denotes the bond which joins B¹ to the double bond, for B² the bond which joins B² to the double bond, for B³ the bond which joins B³ to the double bond, and for B⁴ the bond which joins B⁴ to the double bond.

The polymer according to the invention as per point 4 may especially comprise n¹ mutually linked repeat units of the chemical structure (I) with the definitions of R¹, R², R³, R⁴, R⁶, R⁹, R¹¹, R¹³, R¹⁵, R¹⁷, B¹, B², m¹, m² that are specified for the more preferred embodiment.

The polymer according to the invention as per point 4 may alternatively especially comprise n² mutually linked repeat units of the chemical structure (II) with the definitions of R¹⁹, R²⁰, R²¹, R²², R²³, R²⁵, R²⁷, R²⁹, B³, m³ that are specified for the more preferred embodiment.

Even more preferably, in the polymer according to the invention as per point 4, R¹═R³, R²═R⁴, R¹⁹═R²¹, R²⁰═R²³, R³¹═R³⁴, R³²═R³⁵, and B¹, B², B³, B⁴ are each independently selected from the group consisting of direct bond, methylene, ethylene, n-propylene, where “&&” and “&” are as defined above, where R⁶, R⁹, R¹¹, R¹³, R¹⁵, R¹⁷, R²⁵, R²⁷, R²⁹, R³⁰ are especially independently alkyl having 1 to 6 carbon atoms or H, and R⁶, R⁹, R¹¹, R¹³, R¹⁵, R¹⁷, R²⁵, R²⁷, R²⁹, R³⁰ are preferably each H.

Even more preferably R¹═R³═H, R²═R⁴=alkyl group having 1 to 8 and especially 1 to 6 carbon atoms, R¹⁹═R²⁰═H, R²⁰═R²³=alkyl group having 1 to 8 and especially 1 to 6 carbon atoms, R³¹═R³⁴═H, R³²═R³⁵=alkyl group having 1 to 8 and especially 1 to 6 carbon atoms, and B¹, B², B³, B⁴ are each independently selected from the group consisting of direct bond, methylene, ethylene, n-propylene, where “&&” and “&” are as defined above, where R⁶, R⁹, R¹¹, R¹³, R¹⁵, R¹⁷, R²⁵, R²⁷, R²⁹, R³⁰ are especially independently alkyl having 1 to 6 carbon atoms or H, and R⁶, R⁹, R¹¹, R¹³, R¹⁵, R¹⁷, R²⁵, R²⁷, R²⁹, R³⁰ are preferably each H.

Most preferably, the polymer according to the invention is one of the chemical structure (I) as per point 4 where R¹═R³═H, R²═R⁴=tert-butyl, B¹═B²=methylene, R⁶, R⁹, R¹¹, R¹³, R¹⁵, R¹⁷ are each H.

The polymers according to the invention have, in contrast to those described by Nesvadba et al. and Weng et al, a backbone having double bonds. It has been found that, surprisingly, the polymers according to the invention are suitable for use in batteries, which leads to a higher capacity of the corresponding battery, even after undergoing further charge/discharge cycles.

The polymer according to the invention comprises n¹ mutually linked repeat units of the chemical structure (I) or n² mutually linked repeat units of the chemical structure (II).

In this polymer, n¹ and n² are each independently an integer ≧4, especially an integer ≧4 and ≦5000, preferably an integer ≧10 and ≦1000.

M¹, m², m³ are independently an integer ≧0, especially ≧0 and ≦5000, preferably ≧0 and ≦1000.

In this polymer, the average molar mass (determined by means of size exclusion chromatography with polystyrene standard; DIN 55672-2:2015-02) is especially 700 to 2 000 000 g/mol, preferably 1000 to 1 000 000 g/mol, more preferably 3000 to 300 000 g/mol.

The repeat units of the chemical structure (I) within the polymer are the same or at least partly different from one another. The repeat units of the chemical structure (II) within the polymer are the same or at least partly different from one another.

“At least partly different from one another” means that at least two repeat units differ from one another.

This means, especially in the case of the chemical structure (I), that at least two of the n¹ mutually joined repeat units in at least one of the A¹ to A⁶, R², R³, R⁴, R⁶, R⁹, R¹¹, R¹³, R¹⁵, R¹⁷, B¹, B² radicals differ in the value of m¹, m², the position of A², A³, A⁶ on the central phenyl ring, and/or in the position of R⁶ relative to B¹, of R⁹ relative to B², of R¹¹ relative to R¹³, of R¹⁵ relative to R¹⁷ on the respective double bond. This preferably means, in the case of the chemical structure (I), that at least two of the n¹ mutually joined repeat units differ in at least one of the A¹ to A⁶, R¹, R², R³, R⁴, R⁶, R⁹, R¹¹, R¹³, R¹⁵, R¹⁷, B¹, B² radicals in the value of m¹, m², and/or in the position of A², A³, A⁶ on the central phenyl ring.

This means, especially in the case of the chemical structure (II), that at least two of the n² mutually joined repeat units in at least one of the A⁷ to A¹², R¹⁹, R²⁰, R²¹, R²², R²³, R²⁵, R²⁷, R²⁹, B³ radicals differ in the value of m³ and/or the position of R²⁵ relative to B³, of R²⁷ relative to B²⁹ on the respective double bond. This preferably means, in the case of the chemical structure (II), that at least two of the n² mutually joined repeat units differ in at least one of the A⁷ to A¹², R¹⁹, R²⁰, R²¹, R²², R²³, R²⁵, R²⁷, R²⁹, B³ radicals and/or in the value of m³.

At the same time, the repeat units of the chemical structure (I) within the polymer are joined to one another in such a way that the bond identified by “# #” in a particular repeat unit is joined by the bond identified by “#” in the adjacent repeat unit and the bond identified by “§§” in a particular repeat unit is joined by the bond identified by “§” in the adjacent repeat unit.

At the same time, the repeat units of the chemical structure (II) within the polymer are joined to one another in such a way that the bond identified by “*” in a particular repeat unit is joined by the bond identified by “**” in the adjacent repeat unit.

In this invention, in the structures (I) and (II), several radicals joined via a wavy bond to a first sp²-hybridized carbon atom are shown, this first carbon atom being joined to a second sp²-carbon atom via a double bond. This means that the radical in question may either be cis or trans to the radicals joined to the second carbon atom. R⁶ may accordingly be cis or trans to B¹, R⁹ may accordingly be cis or trans to B², R¹¹ may accordingly be cis or trans to R¹³, R¹⁵ may accordingly be cis or trans to R¹⁷, R²⁵ may accordingly be cis or trans to B³, R²⁷ may accordingly be cis or trans to R²⁹.

The end groups of the first repeat unit of the polymer according to the invention which is present for these in the chemical structure (I) at the bonds defined by “#” and “§”, and the end groups of the n¹th repeat unit of the polymer according to the invention which is present for these in the chemical structure (I) at the bonds defined by “#” and “##”, are not particularly restricted and are a result of the polymerization method used in the method for preparing the polymer according to the invention. Thus, they may be termination fragments of an initiator or a repeat unit. Preferably, these end groups are selected from hydrogen, halogen, hydroxyl, unsubstituted aliphatic radical or aliphatic radical substituted by —CN, —OH, halogen (which may especially be an unsubstituted or correspondingly substituted alkyl group), (hetero)aromatic radical, which is preferably a phenyl radical, benzyl radical or α-hydroxybenzyl.

The end groups of the first repeat unit of the polymer according to the invention which is present for these in the chemical structure (II) at the bond defined by “*”, and the end groups of the n²th repeat unit of the polymer according to the invention which is present for these in the chemical structure (II) at the bond defined by “**”, are not particularly restricted and are a result of the polymerization method used in the method for preparing the polymer according to the invention. Thus, they may be termination fragments of an initiator or a repeat unit. Preferably, these end groups are selected from hydrogen, halogen, hydroxyl, unsubstituted aliphatic radical or aliphatic radical substituted by —CN, —OH, halogen (which may especially be an unsubstituted or correspondingly substituted alkyl group), (hetero)aromatic radical, which is preferably a phenyl radical, benzyl radical or α-hydroxybenzyl.

In the case of B¹, “&&” denotes the bond pointing toward A⁵. This is the chemical bond that joins B¹ to A⁵. In the case of B¹, “&” denotes the bond which joins B¹ to the double bond. This is the other chemical bond in the chemical structure (I) that leads away from B¹, i.e. the chemical bond that joins B¹ to the double bond to which R⁶ is also appended.

In the case of B², “&&” denotes the bond pointing toward A⁶. This is the chemical bond that joins B² to A⁶. In the case of B², “&” denotes the bond which joins B² to the double bond. This is the other chemical bond in the chemical structure (I) that leads away from B², i.e. the chemical bond that joins B² to the double bond to which R⁹ is also appended.

In the case of B³, “&&” denotes the bond pointing toward A⁷. This is the chemical bond that joins B³ to A⁷. In the case of B³, “&” denotes the bond which joins B³ to the double bond. This is the other chemical bond in the chemical structure (II) that leads away from B³, i.e. the chemical bond that joins B³ to the double bond to which R²⁵ is also appended.

In the case of B⁴, “&&” denotes the bond pointing toward A¹³. This is the chemical bond that joins B⁴ to A¹³. In the case of B⁴, “&” denotes the bond which joins B⁴ to the double bond. This is the other chemical bond in the chemical stricture (III) that leads away from B⁴, i.e. the chemical bond that, when the chemical structure (III) is R¹¹, joins B⁴ to the double bond to which R¹³ is also appended, or that, when the chemical structure (III) is R¹⁵, joins B⁴ to the double bond to which R¹⁷ is also appended, or that, when the chemical structure (III) is R¹³, joins B⁴ to the double bond to which R¹¹, or that, when the chemical structure (III) is R¹⁷, joins B⁴ to the double bond to which R¹⁵ is also appended.

An aliphatic radical in the context of the invention is an acyclic or cyclic, saturated or unsaturated, unbranched or branched hydrocarbyl group which is nonaromatic.

An aliphatic radical may be monovalent, i.e. joined to the rest of the molecule only via one of its carbon atoms. A monovalent hydrocarbyl radical is especially a hydrocarbyl group selected from alkyl group, alkenyl group, alkynyl group and saturated or unsaturated cycloalkyl group. In the presence of a double bond an unsaturated cycloalkyl group is called “cycloalkenyl group”, and in the presence of a triple bond a “cycloalkynyl group”.

An aliphatic radical may alternatively be divalent, i.e. joined to the rest of the molecule via two of its carbon atoms. A divalent hydrocarbyl radical is especially a hydrocarbyl group selected from alkylene group, alkenylene group, alkynylene group, and saturated or unsaturated cycloalkylene group. In the presence of a double bond an unsaturated cycloalkylene group is called “cycloalkenylene group”, and in the presence of a triple bond a “cycloalkynylene group”.

When they are not referred to explicitly as divalent in this invention, the term “aliphatic radical” in the context of this invention shall be understood to mean monovalent aliphatic radicals.

In the context of the invention, an “alkyl group” is unbranched or branched and is a monovalent saturated hydrocarbyl radical having the general chemical structure (a) with

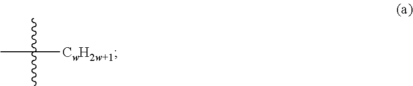

The chain of carbon atoms “—C_{w}H_{2w+1}” may be linear, in which case the group is an unbranched alkyl group. Alternatively, it may have branches, in which case it is a branched alkyl group.

In this case, w in the chemical structure (a) is an integer, especially from the range of 1 to 30, preferably from the range of 1 to 18, more preferably from the range of 1 to 12, even more preferably from the range of 1 to 10, even more preferably still from the range of 1 to 8, most preferably from a range of 1 to 6. W in an unbranched or branched alkyl group having 1 to 30 carbon atoms is selected from the range of 1 to 30. W in an unbranched or branched alkyl group having 1 to 18 carbon atoms is selected from the range of 1 to 18. Win an unbranched or branched alkyl group having 1 to 12 carbon atoms is selected from the range of 1 to 12. W in an unbranched or branched alkyl group having 1 to 10 carbon atoms is selected from the range of 1 to 10. W in an unbranched or branched alkyl group having 1 to 8 carbon atoms is selected from the range of 1 to 8. W in an unbranched or branched alkyl group having 1 to 6 carbon atoms is selected from the range of 1 to 6.

In the context of the invention, an “unbranched or branched alkyl group having 1 to carbon atoms” is especially selected from methyl, ethyl, n-propyl, iso-propyl, n-butyl,

sec-butyl, iso-butyl, tert-butyl, n-pentyl, 1-methylbutyl, 2-methylbutyl, 3-methylbutyl, 1,1-dimethylpropyl, 1,2-dimethylpropyl, 2,2-dimethylpropyl, 1-ethylpropyl, n-hexyl, 1-methylpentyl, 2-methylpentyl, 3-methylpentyl, 4-methylpentyl, 1,1-dimethylbutyl, 1,2-dimethylbutyl,

1,3-dimethylbutyl, 2,2-dimethylbutyl, 2,3-dimethylbutyl, 3,3-dimethylbutyl, 1-ethylbutyl,

2-ethylbutyl, 1,1,2-trimethylpropyl, 1,2,2-trimethylpropyl, 1-ethyl-1-methylpropyl,

1-ethyl-2-methylpropyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-eicosyl, n-heneicosyl, n-docosyl, n-tricosyl, n-tetracosyl, n-pentacosyl, n-hexacosyl, n-heptacosyl, n-octacosyl, n-nonacosyl, n-triacontyl.

In the context of the invention, an “unbranched or branched alkyl group having 1 to 18 carbon atoms” is especially selected from the group consisting of methyl, ethyl,

n-propyl, iso-propyl, n-butyl, sec-butyl, iso-butyl, tert-butyl, n-pentyl, 1-methylbutyl, 2-methylbutyl, 3-methylbutyl, 1,1-dimethylpropyl, 1,2-dimethylpropyl, 2,2-dimethylpropyl, 1-ethylpropyl, n-hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl,

1-ethylbutyl, 2-ethylbutyl, 1,1,2-trimethylpropyl, 1,2,2-trimethylpropyl, 1-ethyl-1-methylpropyl,

1-ethyl-2-methylpropyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl.

In the context of the invention, an “unbranched or branched alkyl group having 1 to 12 carbon atoms” is especially selected from the group consisting of methyl, ethyl,

n-propyl, iso-propyl, n-butyl, sec-butyl, iso-butyl, tert-butyl, n-pentyl, 1-methylbutyl, 2-methylbutyl, 3-methylbutyl, 1,1-dimethylpropyl, 1,2-dimethylpropyl, 2,2-dimethylpropyl, 1-ethylpropyl, n-hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl,

1-ethylbutyl, 2-ethylbutyl, 1,1,2-trimethylpropyl, 1,2,2-trimethylpropyl, 1-ethyl-1-methylpropyl,

1-ethyl-2-methylpropyl, n-heptyl, n-octyl, n-nonyl, n-decyl, n-undecyl, n-dodecyl.

In the context of the invention, an “unbranched or branched alkyl group having 1 to 10 carbon atoms” is especially selected from the group consisting of methyl, ethyl,

n-propyl, iso-propyl, n-butyl, sec-butyl, iso-butyl, tert-butyl, n-pentyl, 1-methylbutyl, 2-methylbutyl, 3-methylbutyl, 1,1-dimethylpropyl, 1,2-dimethylpropyl, 2,2-dimethylpropyl, 1-ethylpropyl, n-hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl,

1-ethylbutyl, 2-ethylbutyl, 1,1,2-trimethylpropyl, 1,2,2-trimethylpropyl, 1-ethyl-1-methylpropyl,

1-ethyl-2-methylpropyl, n-heptyl, n-octyl, n-nonyl, n-decyl.

In the context of the invention, an “unbranched or branched alkyl group having 1 to 8 carbon atoms” is especially selected from the group consisting of methyl, ethyl,

n-propyl, iso-propyl, n-butyl, sec-butyl, iso-butyl, tert-butyl, n-pentyl, 1-methylbutyl, 2-methylbutyl, 3-methylbutyl, 1,1-dimethylpropyl, 1,2-dimethylpropyl, 2,2-dimethylpropyl, 1-ethylpropyl, n-hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl,

1-ethylbutyl, 2-ethylbutyl, 1,1,2-trimethylpropyl, 1,2,2-trimethylpropyl, 1-ethyl-1-methylpropyl,

1-ethyl-2-methylpropyl, n-heptyl, n-octyl.

In the context of the invention, an “unbranched or branched alkyl group having 1 to 6 carbon atoms” is especially selected from the group consisting of methyl, ethyl,

n-propyl, iso-propyl, n-butyl, sec-butyl, iso-butyl, tert-butyl, n-pentyl, 1-methylbutyl, 2-methylbutyl, 3-methylbutyl, 1,1-dimethylpropyl, 1,2-dimethylpropyl, 2,2-dimethylpropyl, 1-ethylpropyl, n-hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl,

1-ethylbutyl, 2-ethylbutyl, 1,1,2-trimethylpropyl, 1,2,2-trimethylpropyl, 1-ethyl-1-methylpropyl,

1-ethyl-2-methylpropyl.

According to the invention, an alkyl group having 1 to 30 carbon atoms is especially an alkyl group having 1 to 18, preferably 1 to 12, more preferably 1 to 10, even more preferably 1 to 8 and most preferably 1 to 6 carbon atoms.

According to the invention, an alkyl group having 1 to 6 carbon atoms is especially an alkyl group having 1 to 4 carbon atoms and even more preferably selected from methyl, ethyl, n-propyl, iso-propyl, n-butyl, sec-butyl, tert-butyl.

In the context of the invention, an “alkenyl group” is unbranched or branched and is obtained from an alkyl group by replacement of at least one CH—CH single bond in the alkyl group by a C═C double bond.

In the context of the invention, an “alkynyl group” is unbranched or branched and is obtained from an alkyl group by replacement of at least one CH₂—CH₂ single bond in the alkyl group by a C≡C triple bond or from an alkenyl group by replacement of at least one CH═CH double bond in the alkenyl group by a C≡C triple bond.

A saturated cycloalkyl group is an alkyl radical in which at least 3 carbon atoms are present within a saturated ring, and may additionally also comprise further carbon atoms not present in the ring. It may be joined to the rest of the molecule via one of these ring carbon atoms or via carbon atoms that are not within the ring. In the context of the invention, a cycloalkyl group is especially selected from cyclopropyl, cyclobutyl, cyclopropylmethyl, cyclopentyl, cyclobutylmethyl, cyclohexyl, cycloheptyl, cyclooctyl, cyclononyl, cyclodecyl, cycloundecyl, cyclododecyl, cyclotridecyl, cyclotetradecyl, cyclopentadecyl.

An unsaturated cycloalkyl group is obtained from a saturated cycloalkyl group by replacement of at least one CH—CH single bond in the saturated cycloalkyl group by at least one C═C double bond (to give the cycloalkenyl group) and/or of a CH₂—CH₂ single bond with a C≡C triple bond (to give the cycloalkynyl group).

An alkylene group in the context of the invention especially has 1 to 30, preferably 1 to 12 and more preferably 1 to 6 carbon atoms and may be branched or unbranched in the context of the invention. “Alkylene group” in the context of the invention denotes a divalent saturated hydrocarbyl radical which can be described by the general chemical structure (b) with

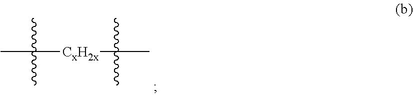

The chain of carbon atoms “—CₓH₂ₓ” may be linear, in which case the group is an unbranched alkylene group. Alternatively, it may have branches, in which case it is a branched alkylene group. X in the chemical structure (b) is an integer.

X in an unbranched or branched alkylene group having 1 to 30 carbon atoms is selected from the range of 1 to 30.

X in an unbranched or branched alkylene group having 1 to 12 carbon atoms is selected from the range of 1 to 12.

X in an unbranched or branched alkylene group having 1 to 6 carbon atoms is selected from the range of 1 to 6.

According to the invention, an alkylene group especially has 1 to 6 carbon atoms and preferably 1 to 4 carbon atoms and is more preferably selected from methylene, ethylene, n-propylene, n-butylene.

In the context of the invention, an “alkenylene group” is unbranched or branched and is obtained from an alkylene group by replacement of at least one CH—CH single bond in the alkylene group by a C═C double bond.

In the context of the invention, an “alkynylene group” is unbranched or branched and is obtained from an alkyl group by replacement of at least one CH₂—CH₂ single bond in the alkylene group by a C≡C triple bond or from an alkenylene group by replacement of at least one CH═CH double bond in the alkenylene group by a C≡C triple bond.

In the context of the invention, a saturated cycloalkylene group is a divalent saturated hydrocarbyl group having at least 3 and especially 3 to 30 carbon atoms and having at least one saturated ring composed of 3 to 30 carbon atoms, preferably a chemical structure I with

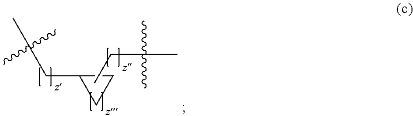

where z′ is especially an integer from 0 to 27; where z″ is especially an integer from 0 to 27; where z′″ is especially an integer from 1 to 28; and where, at the same time, z′+z″+z′″≦28.

In the context of the invention, an unsaturated cycloalkylene group is obtained from a saturated cycloalkylene group by replacement of at least one CH—CH single bond in the cycloalkylene group by a C═C double bond (to give the cycloalkenylene group) and/or by replacement of at least one CH₂—CH₂ single bond in the cycloalkylene group by a C≡C triple bond (to give the cycloalkynylene group).

A (hetero)aromatic radical in the context of the invention is a heteroaromatic or aromatic radical. A (hetero)aromatic radical may be monovalent, i.e. may be bonded to the rest of the molecule via just one of its carbon atoms (in the case of an aromatic radical) or via one of its carbon atoms or heteroatoms (in the case of a heteroaromatic radical).

A (hetero)aromatic radical may alternatively be divalent, i.e. may be bonded to the rest of the molecule via two of its carbon atoms (in the case of an aromatic radical) or may be bonded to the rest of the molecule via two of its carbon atoms, two of its heteroatoms or one of its carbon atoms and one of its heteroatoms (in the case of a heteroaromatic radical).

When they are not referred to explicitly as divalent in this invention, the term “(hetero)aromatic radical” in the context of this invention shall be understood to mean monovalent (hetero)aromatic radicals.

An aromatic radical has exclusively carbon atoms and at least one aromatic ring. An aromatic radical is especially selected from aryl radical, aralkyl radical, alkaryl radical. Aryl radicals have exclusively aromatic rings and are joined to the molecule via a carbon atom in the aromatic ring. An aryl radical is preferably phenyl.

Alkaryl radicals have at least one aromatic ring via which they are joined to the rest of the molecule and additionally also bear alkyl radicals on the aromatic ring. An alkaryl radical is preferably tolyl.

Aralkyl radicals are formally derived by replacement of a hydrocarbyl radical of an alkyl group with an aryl group or an alkaryl group. An alkaryl radical is preferably benzyl, phenylethyl, α-methylbenzyl.

A heteroaromatic radical is especially selected from heteroaryl radical, heteroaralkyl radical, alkylheteroaryl radical. It is an aromatic radical which additionally has at least one heteroatom, especially a heteroatom selected from the group consisting of nitrogen, oxygen, 24anofib, within the aromatic ring or, in the case of a heteroaralkyl radical or an alkylheteroaryl radical, alternatively or additionally outside the aromatic ring.

Preferred (hetero)aromatic radicals selected from the group consisting of a ring of the above identified chemical structure (III), azole, imidazole, pyrrole, pyrazole, triazole, tetrazole, thiophene, furan, thiazole, thiadiazole, oxazole, oxadiazole, pyridine, pyrimidine, triazine, tetrazine, thiazine, benzofuran, purine, indole, 9-anthryl, 9-phenanthryl.

A divalent (hetero)aromatic radical in the context of the invention is a divalent aromatic radical or a divalent heteroaromatic radical.

According to the invention, a divalent aromatic radical is a divalent hydrocarbyl group having at least 6 and preferably 6 to 30 carbon atoms, of which at least 6 carbon atoms are present in an aromatic system and the other carbon atoms, if present, are saturated. The divalent aromatic radical may be joined to the rest of the molecule via carbon atoms in the aromatic system or, if present, saturated carbon atoms.

Preferably, a divalent aromatic radical is a chemical structure (d) with

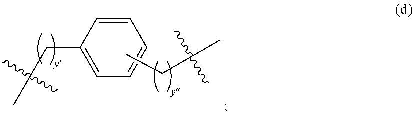

where y′ is an integer ≧0, preferably from 0 to 24; where y″ is an integer ≧0, preferably from 0 to 24; and where preferably, at the same time, y′+y″≦24.

A divalent heteroaromatic radical is a divalent aromatic radical which additionally has at least one heteroatom, especially at least one heteroatom selected from the group consisting of nitrogen, oxygen, 25anofib, within or outside the aromatic ring, preferably within the aromatic ring, but is especially joined to the rest of the molecule via carbon atoms.

“Aliphatic radical optionally substituted by at least one group selected from nitro group, —NH₂, CN, SH, OH, halogen and optionally having at least one group selected from ether, thioether, amino ether, carbonyl group, carboxylic ester group, carboxamide group, sulphonic ester group, phosphoric ester” means that at least one hydrogen atom bonded to a carbon atom in the aliphatic radical may (but need not) be replaced by a group selected from nitro group, —NH₂, —CN, —SH, —OH, halogen and/or that, in the aliphatic radical, at least one CH₂ group joined to two sp³-hybridized carbon atoms, preferably to two —CH₂— groups, more preferably to two —CH₂CH₂— groups, may (but need not) be replaced by an oxygen atom (in which case an ether group is present), a 25anofib atom (in which case a thioether group is present), an NH or N-alkyl group (in which case an amino ether group is present), a —C(═O)— group (in which case a carbonyl group is present), a —C(═O)—O— group (in which case a carboxylic ester group is present), a —C(═O)—NH— or —C(═O)—N(alkyl)-group (in which case a carboxamide group is present), an —SO₂—O— group (in which case a sulphonic ester is present), an —OPO₂—O— group (in which case a phosphoric ester is present).

“Divalent aliphatic radical optionally substituted by at least one group selected from nitro group, —NH₂, CN, SH, OH, halogen and optionally having at least one group selected from ether, thioether, amino ether, carbonyl group, carboxylic ester group, carboxamide group, sulphonic ester group, phosphoric ester” means that at least one hydrogen atom bonded to a carbon atom in the divalent aliphatic radical may (but need not) be replaced by a group selected from nitro group, —NH₂, —CN, —SH, —OH, halogen and/or that, in the aliphatic radical, at least one CH₂ group joined to two sp³-hybridized carbon atoms, preferably to two —CH₂— groups, more preferably to two —CH₂CH₂— groups, may (but need not) be replaced by an oxygen atom (in which case an ether group is present), a 25anofib atom (in which case a thioether group is present), an NH or N-alkyl group (in which case an amino ether group is present), a —C(═O)— group (in which case a carbonyl group is present), a —C(═O)—O— group (in which case a carboxylic ester group is present), a —C(═O)—NH— or —C(═O)—N(alkyl)-group (in which case a carboxamide group is present), an —SO₂—O— group (in which case a sulphonic ester is present), an —OPO₂—O— group (in which case a phosphoric ester is present).

The polymers according to the invention can be prepared in a simple and uncomplicated manner, and from readily obtainable starting materials. Depending on the type of polymerization used, some of the monomers can be prepared from starting materials available commercially at very low cost in just one synthesis stage without chromatographic separation methods, which offers a distinct advance over preparation methods known in the technical literature. No further monomer is needed for polymerization, and preparation methods used may be polymerization processes familiar to those skilled in the art. At the same time, it is possible to obtain polymers having a high molar mass in very high yields. The introduction of polymerizable groups of low molar mass makes it possible to keep the molar mass of the monomer low and to maximize the theoretical capacity (which is inversely proportional to the molar mass) of the secondary electrical charge storage means. In addition, the redox active groups in these polymers are not conjugated to one another; as a consequence, the electrical charge storage means has a flat charging/discharging plateau. These materials differ from the prior art by a very simple synthesis from starting materials available commercially at very low costs in just one synthesis stage in some cases, without chromatographic separation methods. Furthermore, the high redox potential of the polymers according to the invention enables higher cell voltages and specific energies than in the known systems.

The polymers according to this invention may either be homopolymers or copolymers. Homopolymers are polymers which have been synthesized only from one monomer. Copolymers are polymers which have been synthesized from two or more monomers. If two or more monomers are used in the synthesis, the monomers of the repeat units of the polymers, according to this invention, may be present in the polymer in random distribution, as blocks or in alternation. The polymers according to this invention may be present either in linear form [as in structure (II)] or in crosslinked form [as in structure (I)].

The polymers of the invention can be synthesized by polymerization, as known to those skilled in the art, for example by the known polymerization for preparation of polyacetylenes, which preferably proceeds under metal catalysis, of a compound of the structure (I)′ or (II)′ below and optionally also with a compound of the structure (III)′ below. In the structures (I)′ or (II)′ in the scheme below, the R¹′ to R⁴′, R⁶′, R⁹′, R¹¹′, R¹³′, R¹⁹′ to R²³′, R²⁵′, B¹′ to B³′, A¹′ to A¹²′, radicals are each as defined above for R¹ to R⁴, R⁶, R⁹, R¹¹, R¹³, R¹⁹ to R²³, R²⁵, B¹ to B³, A¹ to A¹².

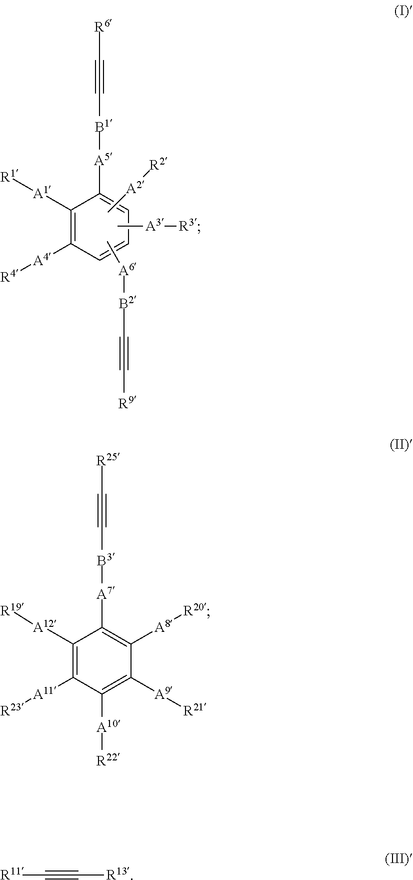

A polymer of the structure (I) can be obtained here by a polymerization in which exclusively monomers of the structure (I)′ are used, such that the polymer of the structure (I) obtained is a homopolymer in which m¹=m²=0.

A polymer of the structure (I) can be obtained here by a polymerization in which monomers of the structure (I)′ and (II)′ are used, such that the polymer of the structure (I) obtained is a copolymer in which m¹, m²≧0 and the R¹¹, R¹³, R¹⁵ or R¹⁷ radical in the above structure (I) is in each case independently a group of the aforementioned general structure (III).

A polymer of the structure (I) can be obtained here by a polymerization in which monomers of the structure (I)′ and (III)′ are used, such that the polymer of the structure (I) obtained is a copolymer in which m¹, m²≧0 and the R¹¹, R¹³, R¹⁵, R¹⁷ radicals in the above structure (I) cannot be a group of the general structure (III).

A polymer of the structure (I) can be obtained here by a polymerization in which monomers of the structure (I)′, (II)′ and (III)′ are used, such that the polymer of the structure (I) obtained is a copolymer in which m¹, m²≧0 and the R¹¹, R¹³, R¹⁵, R¹⁷ radicals in the above structure (I) may each independently also be a group of the aforementioned general structure (III).

A polymer of the structure (II) can be obtained here by a polymerization in which exclusively monomers of the structure (II)′ are used, such that the polymer of the structure (II) obtained is a homopolymer in which m³=0.

A polymer of the structure (II) can be obtained here by a metal-catalysed polymerization in which monomers of the structure (II)′ and (III)′ are used, such that the polymer of the structure (II) obtained is a copolymer in which m³≧0.

The compounds of the structures (I)′ and (II)′ are available to the person skilled in the art via known methods, for example by reaction of a dihydroxybenzene or dibromobenzene with propargyl bromide or acetylene, as outlined in the scheme below (Synthesis Scheme 1). The examples are shown on the basis of the abovementioned structure (I)′ but apply correspondingly to the synthesis of a compound of the abovementioned structure (II)′. R^{A}, R^{B}, R^{C}, R^{D} correspond to A¹′-R¹′, A²′-R²′, A³′-R³′, A⁴′-R⁴′ from the structure (I)′.

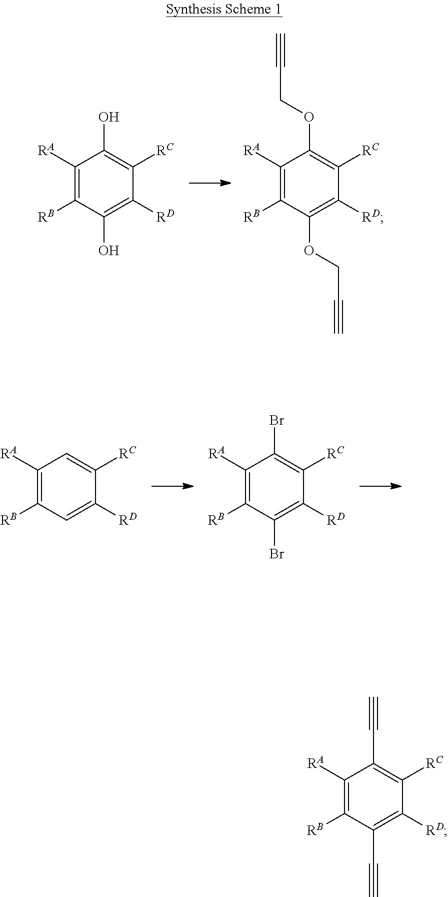

The inventive polymers according to the chemical structures (I) and (II) can be synthesized by polymerization methods familiar to the person skilled in the art, such as the synthesis of polyacetylenes and derivatives thereof from the respective monomers (I)′, (II)′ and (III)′.

It has been found to be advantageous to conduct the polymerization in the presence of conductivity additives, for example the carbon materials described hereinafter (including carbon black, for example “SuperP®”), as described for other polymers in A. Vlad, J. Rolland, G. Hauffman, B. Ernould, J.-F. Gohy, ChemSusChem 2015, 8, 1692-1696.

The polymerization is preferably conducted under metal catalysis within a temperature range from −30 to 150° C., advantageously within a temperature range from 0 to 100° C., in a solvent and in a reaction time of 0.1 to 100 hours, using a catalyst, for example a Wilkinson's catalyst, a Ziegler-Natta catalyst, a Luttinger catalyst, a molybdenum complex, a tungsten complex, a rhodium complex or an electrochemical polymerization method using nickel bromide. There is no restriction in respect of solvents used. Preference is given to organic solvents, for example N,N′-dimethylformamide, N,N′-dimethylacetamide, dimethyl sulphoxide, N-methylpyrrolidone, dichloromethane, 1,2-dichloroethane, toluene, xylene, chlorobenzene, o-dichlorobenzene.

The polymer according to the invention is especially suitable for use as redox-active electrode material in an electrical charge storage means, preferably for storage of electrical energy, and more preferably as a positive electrode element.

More preferably, the redox-active electrode material takes the form of an at least partial surface coating of electrode elements for electrical charge storage means, especially secondary batteries. Electrode elements comprise at least one surface layer and one substrate.

A redox-active material for storage of electrical energy is a material which can store electrical charge and release it again, for example by accepting and releasing electrons. This material can be used, for example, as an active electrode material in an electrical charge storage means. Such electrical charge storage means for storage of electrical energy are especially selected from the group consisting of secondary batteries (also called “accumulators”), redox flow batteries, supercapacitors, and preferably secondary batteries.

Preferably, the electrical charge storage means is a secondary battery. A secondary battery comprises a negative electrode and a positive electrode which are separated from one another by a separator, and an electrolyte which surrounds the electrodes and the separator.

The separator is a porous layer which is ion-permeable and enables the balancing of the charge. The task of the separator is to separate the positive electrode from the negative electrode and to enable balancing of charge through permutation of ions. The separator used in the secondary battery is especially a porous material, preferably a membrane consisting of a polymeric compound, for example polyolefin, polyamide or polyester. In addition, it is possible to use separators made from porous ceramic materials.

The main task of the electrolyte is to assure ion conductivity, which is needed to balance the charge. The electrolyte of the secondary battery may be either a liquid or an oligomeric or polymeric compound having high ion conductivity (“gel electrolyte” or “solid state electrolyte”). Preference is given, however, to an oligomeric or polymeric compound.

If the electrolyte is liquid, it is especially composed of one or more solvents and one or more conductive salts.

The solvent of the electrolytes preferably independently comprises one or more solvents having a high boiling point and high ion conductivity but low viscosity, for example acetonitrile, dimethyl sulphoxide, ethylene carbonate, propylene carbonate, dimethyl carbonate, diethyl carbonate, methyl ethyl carbonate, γ-butyrolactone, tetrahydrofuran, dioxolane, 1,2-dimethoxymethane, 1,2-dimethoxyethane, diglyme, triglyme, tetraglyme, ethyl acetate, 1,3-dioxolane or water.

The conductive salt in the electrolyte consists of a cation of the formula M^{e+} and an anion of the formula An^{f-} of the formula (M^{e+})ₐ(An^{f-})_{b} where e and f are integers depending on the charge of M and An; a and b are integers which represent the molecular composition of the conductive salt.

Cations used in the abovementioned conductive salt are positively charged ions, preferably metals of the first and second main groups, for example lithium, sodium, potassium or magnesium, but also other metals of the transition groups, such as zinc, and organic cations, for example quaternary ammonium compounds such as tetraalkylammonium compounds. The preferred cation is lithium.

Anions used in said conductive salt are preferably inorganic anions such as hexafluorophosphate, tetrafluoroborate, triflate, hexafluoroarsenate, hexafluoroantimonate, tetrafluoroaluminate, tetrafluoroindate, perchlorate, bis(30anofib)borate, tetrachloroaluminate, tetrachlorogallate, but also organic anions, for example N(CF₃SO₂)₂_{^{−}}, CF₃SO₃_{^{−}}, alkoxides, for example tert-butoxide or iso-propoxide, but also halides such as fluoride, chloride, bromide and iodide. The preferred anion is perchlorate, ClO₄_{^{−}}.

The preferred conductive salt is thus LiClO₄.

If ionic liquids are used, they can be used either as solvent of the electrolyte, as conductive salt, or else as complete electrolyte.

In the embodiment in which the redox-active electrode material takes the form of an at least partial surface coating of electrode elements for electrical charge storage means, especially secondary batteries, an electrode element has an at least partial layer on a substrate surface. This layer especially comprises a composition comprising the polymer according to the invention as redox-active material for charge storage and especially at least also a conductivity additive and especially also at least one binder additive.

The application of this composition (expression for composition: “composite”) on the substrate is possible by means of methods known to those skilled in the art. More particularly, the polymer according to the invention is applied on the substrate with the aid of an electrode slurry.

The substrate of the electrode element is especially selected from conductive materials, preferably metals, carbon materials, oxide substances.

Preferred metals are selected from platinum, gold, iron, copper, aluminium or a combination of these metals. Preferred carbon materials are selected from glassy carbon, graphite film, graphene, carbon sheets. Preferred oxide substances are, for example, selected from the group consisting of indium tin oxide (ITO), indium zinc oxide (IZO), antimony zinc oxide (AZO), fluorine tin oxide (FTO) or antimony tin oxide (ATO).

The surface layer of the electrode element comprises at least the polymer according to the invention as redox-active material for charge storage and especially at least a conductivity additive and a binder additive.

The conductivity additive is especially at least one electrically conductive material, preferably selected from the group consisting of carbon materials, electrically conductive polymers, and especially carbon materials. Carbon materials are especially selected from the group consisting of carbon fibres, carbon nanotubes, graphite, carbon black, graphene, and are more preferably carbon fibres. Electrically conductive polymers are especially selected from the group consisting of polyanilines, polythiophenes, polyacetylenes, poly(3,4-ethylenedioxythiophene) polystyrenesulphonate (=PEDOT:PSS), polyarcenes.

Binder additives are especially materials having binder properties and are preferably polymers selected from the group consisting of polytetrafluoroethylene, polyvinylidene fluoride, polyhexafluoropropylene, polyvinyl chloride, polycarbonate, polystyrene, polyacrylates, polymethacrylates, polysulphones, cellulose derivatives, polyurethanes.

The polymer according to the invention is especially applied to the substrate of the electrode element in an electrode slurry.

The electrode slurry is a solution or suspension and comprises the polymer according to the invention and especially the above-described conductivity additive and the above-described binder additive.

The electrode slurry preferably comprises a solvent and further constituents comprising redox-active material for storage of electrical energy (which is especially the polymer according to the invention), and preferably also the conductivity additive and the binder additive.

In the further constituents, preferably, the proportion of the redox-active material for storage of electrical energy (which is especially the polymer according to the invention) is from 5 to 100 percent by weight, the proportion of the conductivity additive from 0 to 80 and preferably 5 to 80 percent by weight, and the proportion of binder additive 0 to 10 and preferably 1 to 10 percent by weight, where the sum total is 100 percent by weight.

Solvents used for the electrode slurry are independently one or more solvents, preferably solvents having a high boiling point, more preferably selected from the group consisting of N-methyl-2-pyrrolidone, water, dimethyl sulphoxide, ethylene carbonate, propylene carbonate, dimethyl carbonate, methyl ethyl carbonate, γ-butyrolactone, tetrahydrofuran, dioxolane, sulpholane, N,N′-dimethylformamide, N,N′-dimethylacetamide. The concentration of the redox-active material, especially of the polymer according to the invention, for storage of electrical energy in the abovementioned electrode slurry is preferably between 0.1 and 10 mg/ml, more preferably between 0.5 and 5 mg/ml.

If the polymer of this invention as redox-active material is used as positive electrode element for electrical charge storage means, the redox-active material used for electrical charge storage in the negative electrode is a material which exhibits a redox reaction at a lower electrochemical potential than the polymer of this invention. Preference is given to those materials selected from the group consisting of carbon materials, which are especially selected from the group consisting of graphite, graphene, carbon black, carbon fibres, carbon 32anofibers, metals or alloys, which are especially selected from the group consisting of lithium, sodium, magnesium, lithium-aluminium, Li—Si, Li—Sn, Li—Ti, Si, SiO, SiO₂, Si—SiO₂ complex, Zn, Sn, SnO, SnO₂, PbO, PbO₂, GeO, GeO₂, WO₂, MoO₂, Fe₂O₃, Nb₂O₅, TiO₂, Li₄Ti₅O₁₂, and Li₂Ti₃O₇, and organic redox-active materials. Examples of organic redox-active materials are compounds having a stable organic radical, compounds having an organosulphur unit, having a quinone structure, compounds having a dione system, conjugated carboxylic acids and salts thereof, compounds having a phthalimide or naphthalimide structure, compounds having a disulphide bond and compounds having a phenanthrene structure and derivatives thereof. If an abovementioned redox-active oligomeric or polymeric compound is used in the negative electrode, this compound may also be a composite, i.e. a composition, consisting of this oligomeric or polymeric compound, a conductivity additive and a binder additive in any ratio. The conductivity additive in this case too is especially at least one electrically conductive material, preferably selected from the group consisting of carbon materials, electrically conductive polymers, and especially carbon materials. Carbon materials are especially selected from the group consisting of carbon fibres, carbon nanotubes, graphite, carbon black, graphene, and are more preferably carbon fibres. Electrically conductive polymers are especially selected from the group consisting of polyanilines, polythiophenes, polyacetylenes, poly(3,4-ethylenedioxythiophene) polystyrenesulphonate (=“PEDOT:PSS”), polyarcenes. Binder additives in this case too are especially materials having binder properties and are preferably polymers selected from the group consisting of polytetrafluoroethylene, polyvinylidene fluoride, polyhexafluoropropylene, polyvinyl chloride, polycarbonate, polystyrene, polyacrylates, polymethacrylates, polysulphones, cellulose derivatives, polyurethanes.

This composite may, as described above, be present as a layer on a substrate through a known film-forming process with the aid of an electrode slurry.

### BRIEF DESCRIPTION OF DRAWINGS

FIG. 1 indicates the measured voltages V (y axis) against the capacity (x axis) of an electrode according to the invention produced with 3 after 1 or 2 charge/discharge cycle(s) (charging rate=1 C, i.e. full charge within 60 minutes; section 4.1). The filled boxes in the diagram denote the charging cycles, the empty boxes the discharging cycles.

FIG. 2 indicates the measured voltages V (y axis) against the capacity (x axis) of an electrode not according to the invention produced with 13 after 1 or 2 or 10 or 50 charge-discharge cycle(s) (charging rate=1 C, i.e. full charge within 60 minutes; section 4.2). The filled boxes in the diagram denote the charging cycles, the empty boxes the discharging cycles.

The invention is to be illustrated in detail hereinafter by the working examples for preparation and use shown in the drawings, without being limited thereto.

Having generally described this invention, a further understanding can be obtained by reference to certain specific examples which are provided herein for purposes of illustration only, and are not intended to be limiting unless otherwise specified.

### EXAMPLES

### 1. General Remarks

### 1.1 Abbreviations

AIBN—azobis(isobutyronitrile); C—carbon particles; Cl-Ph-Chlorobenzene; DMAP—dimethylaminopyridine; DMF—dimethylformamide; NEt₃—triethylamine; ov—overnight; RT—room temperature; TBAClO₄—tetrabutylammonium perchlorate; TBAPF₆—tetrabutylammoniurn hexafluorophosphate; THF—tetrahydrofuran; Tol.—toluene.

### 1.2 Test Methods

¹H and ¹³C NMR spectra were recorded with a Bruker AC 300 (300 MHz) spectrometer at 298 K. For cyclic voltammetry and galvanostatic experiments, a Biologic VMP 3 potentiostat was available. Size exclusion chromatography was conducted on an Agilent 1200 series system (degasser: PSS, pump: G1310A, autosampler: G1329A, oven: Techlab, DAD detector: G1315D, RI detector: G1362A, eluent: DMAc+0.21% LiCl, 1 ml/min, temperature: 40° C., column: PSS GRAM guard/1000/30 Å).

### 2. Inventive Examples

### 2.1 I1: Synthesis and polymerization of 1,4-di-tert-butyl-2,5-bis(prop-2-yn-1-yloxy)benzene 2

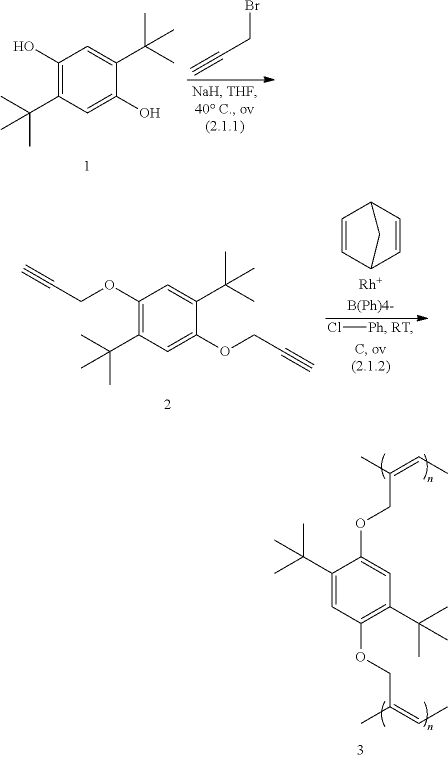

### 2.1.1 Synthesis of 1,4-di-tertt-butyl-2,5-bis(prop-2-yn-1-yloxy)benzene 2

A 0.5 M solution of 2,5-di-tert-butylhydroquinone 1 (2.22 g, 10 mmol) in THF was added dropwise to an ice-cooled suspension of NaH (1 g, 25 mmol, 60% dispersion in mineral oil) in 10 ml of THF and, on completion of addition, the mixture was stirred at room temperature for another 1 hour. Subsequently, propargyl bromide (2.68 ml, 30 mmol, 80 w % in toluene) was added and the reaction mixture was stirred at 40° C. for 16 hours. The reaction was quenched with water and extracted with diethyl ether. The organic phase was dried with MgSO₄, the solvent was removed under reduced pressure and the residue was purified by means of column chromatography (silica gel, CH₂Cl₂/heptane, 1/1). 2.66 g (8.9 mmol, 89%) of 5 were obtained in the form of a pale yellow solid.

¹H NMR (CDCl₃, 300 MHz, ppm): δ 7.00 (s, 2H), 4.70 (d, 4H), 2.52 (t, 2H), 1.28 (s, 18H).

### 2.1.2 Polymerization of 1,4-di-tert-butyl-2,5-bis(prop-2-yn-1-yloxy)benzene 2 in the presence of carbon to give 3

1,4-Di-tert-butyl-2,5-bis(prop-2-yn-1-yloxy)benzene 2 (40 mg, 0.13 mmol) and 80 mg of Super P® were inertized and dispersed with 4 ml of chlorobenzene. Rhodium norbornadiene tetraphenylborate (5 mol %, 3.4 mg, 6.7 μmol) in 50 μl of chlorobenzene were inertized by 3 freeze-pump-thaw cycles. Subsequently, the initiator was added to the monomer and the reaction was stirred at room temperature for 16 hours. The gel obtained was transferred directly into a Soxhlet apparatus. It was extracted therein with acetonitrile and diethyl ether and then dried. 109 mg of 3 were obtained in the form of a black powder.

Elemental analysis: C, 94.29%; H, 2.49%; corresponds to about 28% polymer in composite.

### 2.2 I2: Synthesis and polymerization of 1,4-di-tert-butyl-2-(prop-2-yn-1-yloxy)-5-methoxybenzene 5

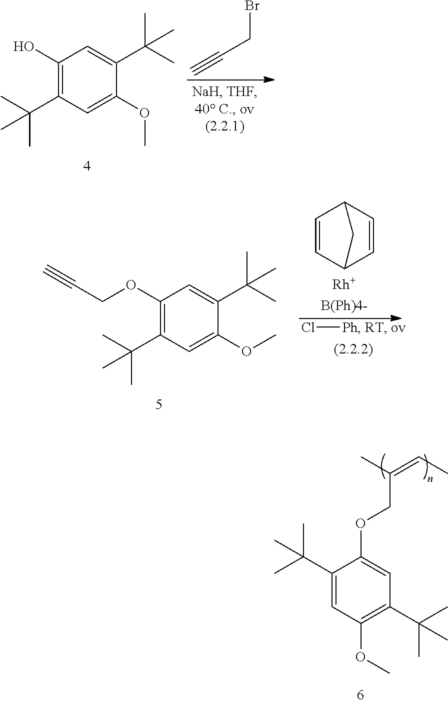

### 2.2.1 Synthesis of 1,4-di-tert-butyl-2-(prop-2-yn-1-yloxy)-5-methoxybenzene 5

A 0.5 M solution of 2,5-di-tert-butyl-4-methoxyphenol 4 (2.36 g, 10 mmol) in THF was added dropwise to an ice-cooled suspension of NaH (600 mg, 15 mmol, 60% dispersion in mineral oil) in 8 ml of THF and, on completion of addition, the mixture was stirred at room temperature for another 1 hour. Subsequently, propargyl bromide (1.34 ml, 15 mmol, 80% by weight in toluene) was added and the reaction mixture was stirred at 40° C. for 16 hours. The reaction was quenched with water and extracted with diethyl ether. The organic phase was dried with MgSO₄, the solvent was removed under reduced pressure and the residue was obtained by means of column chromatography (silica gel, CH₂Cl₂/heptane, 1/1). 2.17 g (7.9 mmol, 79%) of 5 were obtained in the form of a pale yellow oil.

¹H NMR (CDCl₁, 300 MHz, ppm): δ 7.00 (s, 1H), 6.92 (s, 1H), 4.70 (d, 2H), 3.65 (s, 3H), 2.50 (t, 1H), 1.24 (s, 18H).

### 2.2.2 Polymerization of 1,4-di-tert-butyl-2-(prop-2-yn-1-yloxy)-5-methoxybenzene 5 to give 6

A 1 M solution of 5 (192 mg, 0.7 mmol) in chlorobenzene and a solution of rhodium norbonadiene tetraphenylborate (3 mol %, 10.8 mg, 21 μmol) in 50 μl of chlorobenzene was inertized by 3 freeze-pump-thaw cycles. Subsequently, the initiator was added to the monomer and the reaction was stirred at room temperature for 16 hours. The viscous solution obtained was precipitated in acetonitrile. This gave 174.7 mg (91%) of 6 in the form of a red powder.

### 3. Comparative Examples

### 3.1 C1: Synthesis and polymerization of ((2,5-di-tert-butyl-1,4-phenylene)bis(oxy))bis(pronane-3,1-diyl)bis(2-methyl acrylate) 12

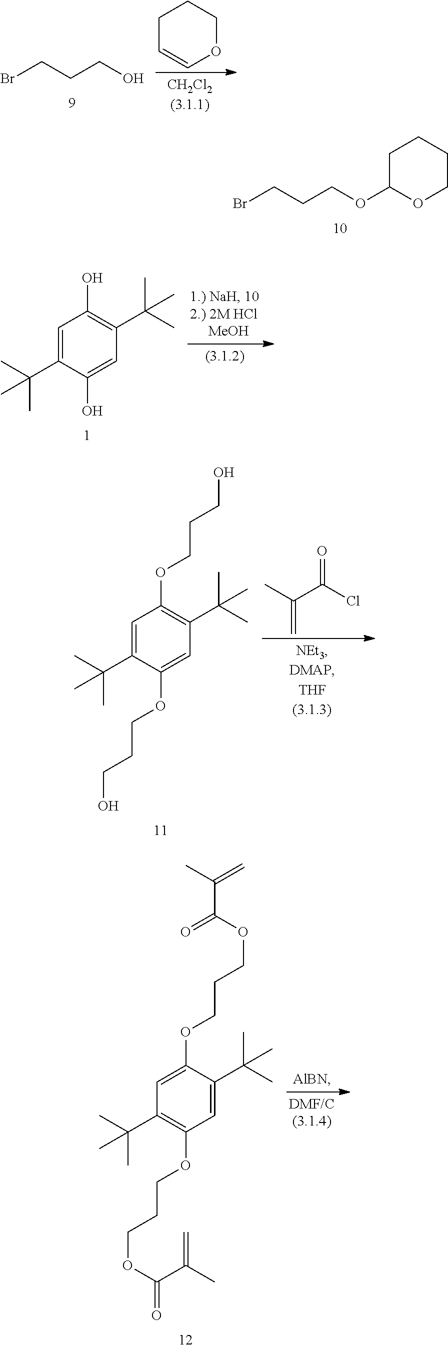

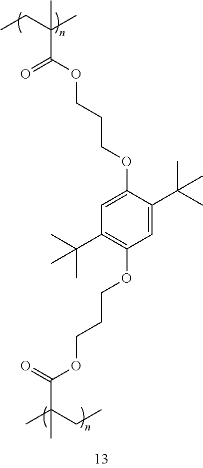

3.1.1 Synthesis of 2-(3-bromopropoxy)tetrahydro-2H-pyran 10

Stirred into a 0.5 M solution of 1-bromo-3-hydroxypropane 9 (10 g, 72 mmol) in CH₂Cl₂ were p-toluenesulphonic acid hydrate (1.37 g, 7.2 mmol) and dihydropyran (9.8 ml, 107.9 mmol), and the mixture was stirred at room temperature for 16 hours. The reaction was extracted with water. The organic phase was dried with MgSO₄, the solvent was removed under reduced pressure and the residue was purified by means of vacuum distillation. 12.2 g (54.7 mmol, 76%) of 10 were obtained as a colourless oil.

¹H NMR (CDCl₃, 300 MHz, ppm): δ 4.52 (s, 1H), 3.78 (m, 2H), 3.46 (m, 4H), 2.05 (m, 2H), 1.68 (m, 2H), 1.46 (m, 4H).

### 3.1.2 Synthesis of 3,3′-((2,5-di-tert-butyl-1,4-phenylene)bis(oxy))bis(propan-1-ol) 11

To a 0.9 M solution of 1 (1 g, 4.5 mmol) in THF was added dropwise an ice-cooled suspension of NaH (450 mg, 11.2 mmol, 60% dispersion in mineral oil) in 10 mL of THF and, on completion of addition, the mixture was stirred at room temperature for another 2 hours. Subsequently, 10 (5.02 g, 22.5 mmol) was added and the reaction mixture was stirred at 50° C. for 24 hours. The reaction was quenched with water and extracted with dichloromethane. The organic phase was dried with MgSO₄ and the solvent was removed under reduced pressure. Without further purification, the residue was taken up in 50 ml of methanol, and 20 ml of 2 M HCl were added. After detachment of the protecting group (monitoring by TLC), the product was extracted with dichloromethane and dried over MgSO₄, and the solvent was removed under reduced pressure. The residue was purified by means of column chromatography (silica gel, hexane/ethyl acetate, 1:1). 853 mg (2.5 mmol, 56%) of 11 were obtained as a white solid.

¹H NMR (CDCl₃, 300 MHz, ppm): δ 6.85 (s, 2H), 4.10 (t, 4H), 3.92 (t, 4H), 2.09 (m, 4H), 1.37 (s, 18H).

### 3.1.3 Synthesis of ((2,5-di-tert-butyl-1,4-phenylene)bis(oxy))bis(propane-3,1-diyl)-bis(2-methyl acrylate) 12

11 (505 mg, 1.5 mmol) and DMAP (18 mg, 0.15 mmol) were inertized. 10 ml of dry THF, triethylamine (820 μl, 5.9 mmol) and methacryloyl chloride (570 μl, 5.9 mmol) were added while cooling and the mixture was stirred at room temperature for 16 hours. The reaction was quenched with water and extracted with dichloromethane. The organic phase was dried with MgSO₄ and the solvent was removed under reduced pressure. The residue was purified by means of column chromatography (silica gel, hexane/ethyl acetate, 4:1). 565 mg (1.2 mmol, 80.6%) of 12 were obtained as a white solid.

¹H NMR (CDCl₃, 300 MHz, ppm): δ 6.83 (s, 2H), 6.12 (s, 2H), 5.56 (s, 2H), 4.39 (t, 4H), 4.07 (t, 4H), 2.21 (m, 4H), 1.95 (s, 6H), 1.37 (s, 18H).

### 3.1.4 Polymerization of ((2,5-di-tert-butyl-1,4-phenylene)bis(oxy))bis(propane-3,1-diyl)bis(2-methyl acrylate) 12 to give 13 in the presence of carbon

Monomer 12 (40 mg, 0.08 mmol), AIBN (0.7 mg, 0.004 mmol) and 80 mg SuperP® (carbon particles, acquired from Sigma Aldrich) were inertized. Subsequently, 2.5 ml of dry toluene were added and the reaction was stirred at 80° C. for 54 hours. The composite was precipitated and washed in methanol. This gave 105 mg of 13 in the form of a black solid.

Elemental analysis: C, 92.06%; H, 2.38%; corresponds to about 27% polymer in composite.

### 3.2 C2: Synthesis and polymerization of 3-(2,5-di-tert-butyl-4-methoxyphenoxy)propyl methacrylate 15

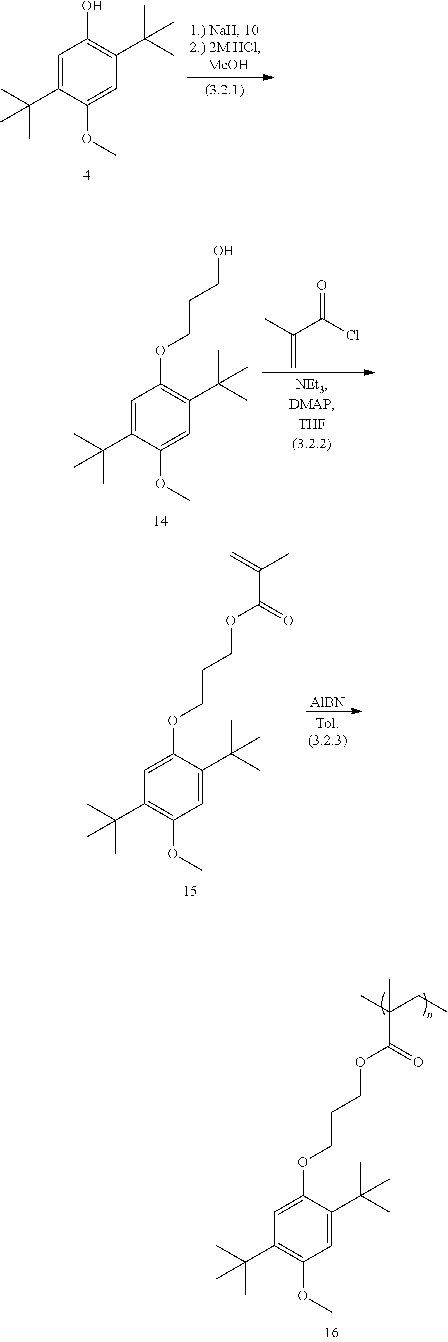

### 3.2.1 Synthesis of 3-(2,5-di-tert-butyl-4-methoxyphenoxy)propan-1-ol 14

A 0.8 M solution of 4 (2 g, 8.5 mmol) in THF was added dropwise to an ice-cooled suspension of NaH (507 mg, 12.7 mmol, 60% dispersion in mineral oil) in 10 mL of THF and, on completion of addition, the mixture was stirred at room temperature for another 2 hours. Subsequently, 10 (5.66 g, 25.4 mmol) was added and the reaction mixture was stirred at 50° C. for 48 hours. The reaction was quenched with water and extracted with dichloromethane. The organic phase was dried with MgSO₄ and the solvent was removed under reduced pressure. The residue was taken up in 50 ml of methanol, and 20 ml of 2 M HCl were added. After detachment of the protecting group, the product was extracted with dichloromethane and dried over MgSO₄, and the solvent was removed under reduced pressure. The residue was purified by means of gel filtration (silica gel, hexane/ethyl acetate, 4:1). 1.62 g (5.5 mmol, 65%) of 14 were obtained as a white solid.

¹H NMR (CDCl₃, 300 MHz, ppm): δ 6.84 (d, 2H), 4.11 (t, 2H), 3.92 (t, 2H), 3.81 (s, 3H), 2.09 (m, 2H), 1.37 (d, 18H).

### 3.2.2 Synthesis of 3-(2,5-di-tert-butyl-4-methoxyphenoxy)propyl methacrylate 15

14 (500 mg, 1.7 mmol) and DMAP (20.8 mg, 0.17 mmol) were inertized. 10 ml of dry THF, triethylamine (940 μl, 6.8 mmol) and methacryloyl chloride (660 μl, 6.8 mmol) were added while cooling and the mixture was stirred at room temperature for 16 hours. The reaction was quenched with water and extracted with dichloromethane. The organic phase was dried with MgSO₄ and the solvent was removed under reduced pressure. The residue was purified by means of column chromatography (silica gel, hexane/ethyl acetate, 4:1). 545 mg (1.5 mmol, 88.5%) of 15 were obtained as a white solid.

¹H NMR (CDCl₃, 300 MHz, ppm): δ 6.83 (d, 2H), 6.12 (s, 1H), 5.56 (s, 1H), 4.39 (t, 2H), 4.07 (t, 2H), 3.80 (s, 3H), 2.21 (m, 2H), 1.95 (s, 3H), 1.36 (d, 18H).

### 3.2.3 Polymerization of 3-(2,5-di-tert-butyl-4-methoxyphenoxy)propyl methacrylate 15 to give 16

A 0.5 M solution of 15 (100 mg, 0.275 mmol) in dry toluene and AIBN (1.72 mg, 0.13 mmol) was degassed with argon for 90 min. The degassed mixture was stirred at 80° C. for 16 hours. The polymer was precipitated in methanol. This gave 65 mg (0.18 mmol, 64.5%) of 16 as a white solid.

### 4. Production of the Electrodes

### 4.1 Production of an Electrode Comprising 3 (Inventive Example)

3 (prepared as described in section 2.1.2) was processed in a mortar to give a fine powder. Subsequently added to 90 mg of 3 and 10 mg of poly(vinylidene fluoride) (PVDF; Sigma Aldrich as binder additive) was 1 ml of NMP (N-methyl-2-pyrrolidone), and the mixture was mixed in a mortar for five minutes until a homogeneous paste formed. This paste was applied to aluminium foil (15 μm, MIT Corporation) using a doctor blade method or with the aid of a coating bar and the electrode was dried at 45° C. under reduced pressure for 16 hours. The proportion of the active material on the electrodes was determined on the basis of the masses of dried electrodes. The button cells (2032 type) were constructed under an argon atmosphere. Suitable electrodes were punched out with the aid of an MIT Corporation Precision Disc Cutter (diameter 15 mm). The electrode being used as cathode was positioned at the base of the button cell and separated from the lithium anode with the aid of a porous polypropylene membrane (Celgard, MIT Corporation). Subsequently positioned atop the lithium anode were a stainless steel weight (diameter: 15.5 mm, thickness: 0.3 mm, MIT Corporation) and a stainless steel spring (diameter: 14.5 mm, thickness: 5 mm). The button cell was filled with electrolyte (EC/DMC 3/7, 0.5 M LiClO₄) and covered with the lid before being sealed with an electrical compression machine (MIT Corporation MSK-100D).

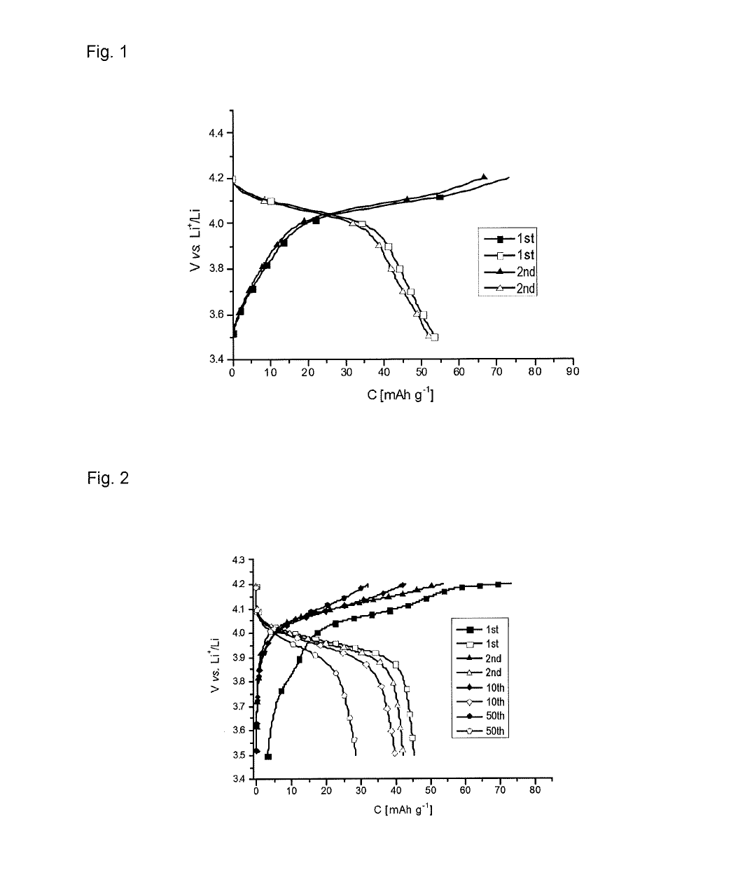

In the first discharge cycle, the battery shows a capacity of 52 mAh/g (58% of the theoretically possible capacity); after 2 charge/discharge cycles, the battery still shows a capacity of more than 50 mAh/g (FIG. 1=FIG. 1).

### 4.2 Production of an Electrode Comprising 13 (Comparative Example)

13 (prepared as described in section 3.1.4) was processed in a mortar to give a fine powder. Subsequently added to 90 mg of 13 and 10 mg of poly(vinylidene fluoride) (PVDF; Sigma Aldrich as binder additive) was 1 ml of NMP (N-methyl-2-pyrrolidone), and the mixture was mixed in a mortar for five minutes until a homogeneous paste formed. This paste was applied to aluminium foil (15 μm, MIT Corporation) using a doctor blade method with the aid of a coating bar and the electrode was dried at 45° C. under reduced pressure for 16 hours. The proportion of the active material on the electrodes was determined on the basis of the masses of dried electrodes. The button cells (2032 type) were constructed under an argon atmosphere. Suitable electrodes were punched out with the aid of an MIT Corporation Precision Disc Cutter (diameter 15 mm). The electrode being used as cathode was positioned at the base of the button cell and separated from the lithium anode with the aid of a porous polypropylene membrane (Celgard, MIT Corporation). Subsequently positioned atop the lithium anode were a stainless steel weight (diameter: 15.5 mm, thickness: 0.3 mm, MIT Corporation) and a stainless steel spring (diameter: 14.5 mm, thickness: 5 mm). The button cell was filled with electrolyte (EC/DMC 3/7, 0.5 M LiClO₄) and covered with the lid before being sealed with an electrical compression machine (MIT Corporation MSK-100D).

In the first discharge cycle, the battery shows a capacity of 45 mAh/g (80% of the theoretically possible capacity); after 50 charge/discharge cycles the battery shows a capacity of 29 mAh/g (FIG. 2=FIG. 2).

### 5. Results

It is clear from the comparison of FIG. 1 with FIG. 2 that the polymer electrodes of the invention have both a higher discharge voltage and discharge capacity and consequently a much higher specific energy compared to those obtained in the prior art. This effect was observed over several charge/discharge cycles. In addition, it was possible to produce the polymers in a much less resource-intensive manner.

European patent application EP15182453 filed Aug. 26, 2015, is incorporated herein by reference.

Numerous modifications and variations on the present invention are possible in light of the above teachings. It is therefore to be understood that within the scope of the appended claims, the invention may be practiced otherwise than as specifically described herein.

1. Polymer comprising n¹ mutually linked repeat units of the chemical structure (I) or n² mutually linked repeat units of the chemical structure (II) with 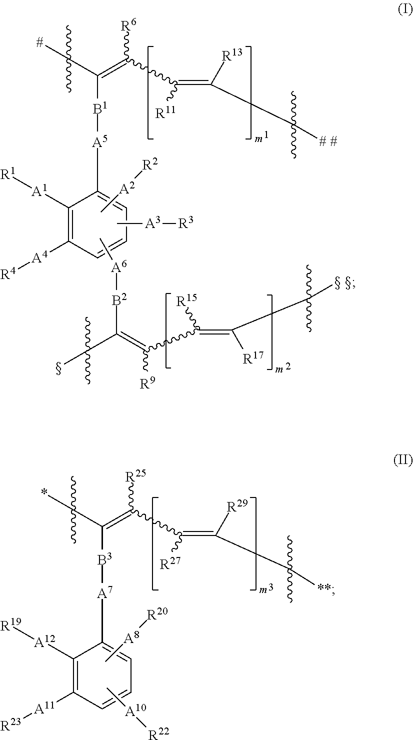
where n¹ and n² are each independently an integer ≧4,
where m¹, m², m³ are each independently an integer ≧0,
where the repeat units of the chemical structure (I) within the polymer are the same or at least partly different from one another,
where the repeat units of the chemical structure (II) within the polymer are the same or at least partly different from one another,
where the repeat units of the chemical structure (I) within the polymer are joined to one another in such a way that the bond identified by “# #” in a particular repeat unit is joined by the bond identified by “#” in the adjacent repeat unit and the bond identified by “§§” in a particular repeat unit is joined by the bond identified by “§” in the adjacent repeat unit,
where the repeat units of the chemical structure (II) within the polymer are joined to one another in such a way that the bond identified by “*” in a particular repeat unit is joined by the bond identified by “**” in the adjacent repeat unit,
where the R¹, R², R³, R⁴, R⁶, R⁹, R¹¹, R¹³, R¹⁵, R¹⁷, R¹⁹, R²⁰, R²¹, R²², R²³, R²⁵, R²⁷, R²⁹ radicals are each independently selected from the group consisting of
hydrogen, (hetero)aromatic radical,
aliphatic radical optionally substituted by at least one group selected from nitro group, —NH₂, —CN, —SH, —OH, halogen and optionally having at least one group selected from ether, thioether, amino ether, carbonyl group, carboxylic ester group, carboxamide group, sulphonic ester group, phosphoric ester,
where at least two of A¹, A², A³, A⁴, A⁵, A⁶ are each an oxygen or sulphur atom and the others of A1, A², A³, A⁴, A⁵, A⁶ are each a direct bond,
where at least two of A⁷, A⁸, A⁹, A¹⁰, A¹¹, A¹² are each an oxygen or sulphur atom and the others of A⁷, A⁸, A⁹, A¹⁰, A¹¹, A¹² are each a direct bond,
and where at least two radicals in ortho positions to one another among the R¹, R², R³, R⁴ radicals and/or at least two radicals in ortho positions to one another among the R¹⁹, R²⁰, R²¹, R²², R²³ radicals may each also be bridged by at least one (hetero)aromatic ring or aliphatic ring optionally substituted by at least one group selected from nitro group, —NH₂, —CN, —SH, —OH, halogen, alkyl group and optionally having at least one group selected from ether, thioether, amino ether, carbonyl group, carboxylic ester group, carboxamide group, sulphonic ester group, phosphoric ester,
and where the R¹ radical in the case that A¹=direct bond, the R² radical in the case that A²=direct bond, the R³ radical in the case that A³=direct bond, the R⁴ radical in the case that A⁴=direct bond, the R¹⁹ radical in the case that A¹²=direct bond, the R²⁰ radical in the case that A⁸=direct bond, the R^{2′} radical in the case that A⁹=direct bond, the R²² radical in the case that A¹⁰=direct bond, the R²³ radical in the case that A¹¹=direct bond and the R⁶, R⁹, R¹¹, R¹³, R¹⁵, R¹⁷, R²⁵, R²⁷, R²⁹ radicals may each also be selected from the group consisting of
nitro group, —CN, —F, —Cl, —Br, —I, —COOR³⁶, —C(═O)NHR³⁷, —NR³⁸R³⁹, where R³⁶, R³⁷, R³⁸, R³⁹ are each independently selected from the group consisting of hydrogen, (hetero)aromatic radical, aliphatic radical optionally substituted by at least one group selected from nitro group, —NH₂, —CN, —SH, —OH, halogen and optionally having at least one group selected from ether, thioether, amino ether, carbonyl group, carboxylic ester group, carboxamide group, sulphonic ester group, phosphoric ester,
and where the R⁶, R⁹, R¹¹, R¹³, R¹⁵, R¹⁷, R²⁵, R²⁷, R²⁹ radicals may independently also be a radical of the formula —O—R⁴⁰ where R⁴⁰ is an aliphatic radical optionally substituted by at least one group selected from nitro group, —NH₂, —CN, —SH, —OH, halogen and optionally having at least one group selected from ether, thioether, amino ether, carbonyl group, carboxylic ester group, carboxamide group, sulphonic ester group, phosphoric ester,
where B¹, in the case that A⁵=O or S, B² in the case that A⁶=O or S, B³ in the case that A⁷=O or S, are each independently selected from the group consisting of
direct bond,
&-(X¹)ₚ₁—[C═X²]ₚ₂—(X³)ₚ₃—B⁵—(Y²)_{q2}—[C═Y¹]_{q1}—&&,
&-(Y³)_{q3}—(C═Y⁴)-&&,
and where B¹, in the case that A⁵=direct bond, B² in the case that A⁶=direct bond, B³ in the case that A⁷=direct bond, are independently selected from the group consisting of
&-(X⁴)ₚ₄—[C═X⁵]ₚ₅—(X⁶)ₚ₆—B⁶—(Y⁷)_{q6}—[C═Y⁶]_{q5}(Y⁵)_{q4}-&&,
&-(Y¹⁰)_{q9}—(C═Y⁹)_{q8}—(Y⁸)_{q7}-&&,
where p1, p2, p3 are each 0 or 1, with the proviso that it is not simultaneously true that p1=p3=1 and p2=0,
where p4, p5, p6 are each 0 or 1, with the proviso that it is not simultaneously true that p4=p6=1 and p5=0,
where q1, q2 are each 0 or 1, where, when q1=0, then q2=0,
where q3=0 or 1,
where q4, q5, q6 are each 0 or 1, with the proviso that it is not simultaneously true that q4=q6=1 and q5=0,
where q7, q8, q9 are each 0 or 1, with the proviso that it is not simultaneously true that q7=q9=1 and q8=0, and that, when q7=1 and q8=0, then q9=0,
where X², X⁵, Y¹, Y⁴, Y⁶, Y⁹ are independently selected from the group consisting of oxygen, sulphur,
where X¹, X³, X⁴, X⁶, Y², Y³, Y⁷, Y¹⁰ are independently selected from the group consisting of O, S, NH, N-alkyl,
where Y⁵, Y⁸ is selected from NH, N-alkyl,
where B⁵, B⁶ are independently selected from the group consisting of
divalent (hetero)aromatic radical,
divalent aliphatic radical optionally substituted by at least one group selected from nitro group, —NH₂, —CN, —SH, —OH, halogen and optionally having at least one group selected from ether, thioether, amino ether, carbonyl group, carboxylic ester group, carboxamide group, sulphonic ester group, phosphoric ester,
and where “&&” for B¹ denotes the bond pointing toward A⁵, for B² the bond pointing toward A⁶, and for B³ the bond pointing toward A⁷,
and where “&” for B¹ denotes the bond which joins B¹ to the double bond, for B² the bond which joins B² to the double bond, and for B³ the bond which joins B³ to the double bond.

2. Polymer according to claim 1 comprising n¹ mutually linked repeat units of the chemical structure (I) or n² mutually linked repeat units of the chemical structure (II) with 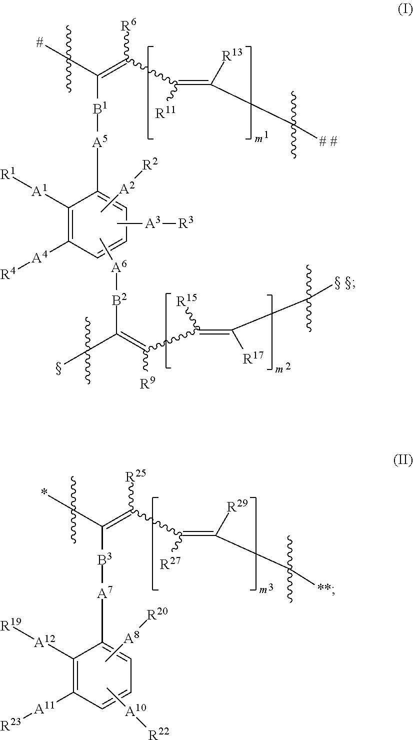
where n¹ and n² are each independently an integer ≧4,
where m¹, m², m³ are each independently an integer ≧0,
where the repeat units of the chemical structure (I) within the polymer are the same or at least partly different from one another,
where the repeat units of the chemical structure (II) within the polymer are the same or at least partly different from one another,
where the repeat units of the chemical structure (I) within the polymer are joined to one another in such a way that the bond identified by “# #” in a particular repeat unit is joined by the bond identified by “#” in the adjacent repeat unit and the bond identified by “§§” in a particular repeat unit is joined by the bond identified by “§” in the adjacent repeat unit,
where the repeat units of the chemical structure (II) within the polymer are joined to one another in such a way that the bond identified by “*” in a particular repeat unit is joined by the bond identified by “**” in the adjacent repeat unit,
where the R¹, R², R³, R⁴, R⁶, R⁹, R¹¹, R¹³, R¹⁵, R¹⁷, R¹⁹, R²⁰, R²¹, R²², R²³, R²⁵, R²⁷, R²⁹ radicals are each independently selected from the group consisting of
hydrogen, phenyl, benzyl,
aliphatic radical optionally substituted by at least one group selected from nitro group, —NH₂, —CN, —SH, —OH, halogen and optionally having at least one group selected from ether, thioether, amino ether, carbonyl group, carboxylic ester group, carboxamide group, sulphonic ester group, phosphoric ester,
and where the R¹¹, R¹³, R¹⁵, R¹⁷ radicals may each independently also be a group of the general structure (III) with 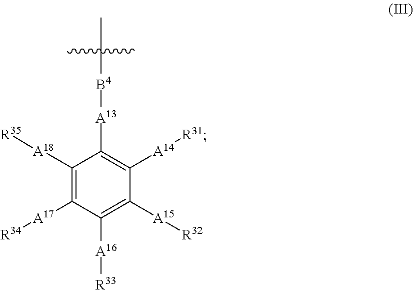
in which the R³¹, R³², R³³, R³⁴, R³⁵ radicals may independently be as defined for R¹,
where at least two of A¹, A², A³, A⁴, A⁵, A⁶ are each an oxygen or sulphur atom, and the others of A¹, A², A³, A⁴, A⁵, A⁶ are each a direct bond,
where at least two of A⁷, A⁸, A⁹, A¹⁰, A¹² are each an oxygen or sulphur atom, and the others of A⁷, A⁸, A⁹, A¹⁰, A¹¹, A¹² are each a direct bond,
where at least two of A¹³, A¹⁴, A¹⁵, A¹⁶, A¹⁷, A¹⁸ are each an oxygen or sulphur atom, and the others of A¹³, A¹⁴, A¹⁵, A¹⁶, A¹⁷, A¹⁸ are each a direct bond,
and where at least two radicals in ortho positions to one another among the R¹, R², R³, R⁴ radicals and/or at least two radicals in ortho positions to one another among the R¹⁹, R²⁰, R²¹, R²², R²³ radicals and/or at least two radicals in ortho positions to one another among the R³¹, R³², R³³, R³⁴, R³⁵ radicals may each also be bridged by at least one (hetero)aromatic ring or aliphatic ring optionally substituted by at least one group selected from nitro group, —NH₂, —CN, —SH, —OH, halogen, alkyl group and optionally having at least one group selected from ether, thioether, amino ether, carbonyl group, carboxylic ester group, carboxamide group, sulphonic ester group, phosphoric ester,
and where the R¹ radical in the case that A¹=direct bond, the R² radical in the case that A²=direct bond, the R³ radical in the case that A³=direct bond, the R⁴ radical in the case that A⁴=direct bond, the R¹⁹ radical in the case that A¹²=direct bond, the R²⁰ radical in the case that A⁸=direct bond, the R²¹ radical in the case that A⁹=direct bond, the R²² radical in the case that A¹⁰=direct bond, the R²³ radical in the case that A¹¹=direct bond, the R³¹ radical in the case that A¹⁴=direct bond, the R³² radical in the case that A¹⁵=direct bond, the R³³ radical in the case that A¹⁶=direct bond, the R³⁴ radical in the case that A¹⁷=direct bond, the R³⁵ radical in the case that A¹⁸=direct bond and the R⁶, R⁹, R¹¹, R¹³, R¹⁵, R¹⁷, R²⁵, R²⁷, R²⁹ radicals may each also be selected from the group consisting of
nitro group, —CN, —F, —Cl, —Br, —I, —COOR³⁶, —C(═O)NHR³⁷, —NR³⁸R³⁹, where R³⁶, R³⁷, R³⁸, R³⁹ are each independently selected from the group consisting of hydrogen, (hetero)aromatic radical, aliphatic radical optionally substituted by at least one group selected from nitro group, —NH₂, —CN, —SH, —OH, halogen and optionally having at least one group selected from ether, thioether, amino ether, carbonyl group, carboxylic ester group, carboxamide group, sulphonic ester group, phosphoric ester,
and where the R⁶, R⁹, R¹¹, R¹³, R¹⁵, R¹⁷, R²⁵, R²⁷, R²⁹ radicals may independently also be a radical of the formula —O—R⁴⁰ where R⁴⁰ is an aliphatic radical optionally substituted by at least one group selected from nitro group, —NH₂, —CN, —SH, —OH, halogen and optionally having at least one group selected from ether, thioether, amino ether, carbonyl group, carboxylic ester group, carboxamide group, sulphonic ester group, phosphoric ester,
where B¹, in the case that A⁵=O or S, B² in the case that A⁶=O or S, B³ in the case that A⁷=O or S, B⁴ in the case that A¹³=O or S, are independently selected from the group consisting of
direct bond,
&-(X¹)ₚ₁—[C═X²]ₚ₂—(X³)ₚ₃—B⁵—(Y²)_{q2}—[C═Y¹]_{q1}-&&,
&-(Y³)_{q3}—(C═Y⁴)-&&,
and where B¹, in the case that A⁵=direct bond, B² in the case that A⁶=direct bond, B³ in the case that A⁷=direct bond, B⁴ in the case that A¹³=direct bond, are independently selected from the group consisting of
&-(X⁴)ₚ₄—[C═X⁵]ₚ₅—(X⁶)ₚ₆—B⁶—(Y⁷)_{q6}—[C═Y⁶]_{q5}—(Y⁵)_{q4}-&&,
&-(Y¹⁰)_{q9}—(C═Y⁹)_{q8}—(Y⁸)_{q7}-&&,
where p1, p2, p3 are each 0 or 1, with the proviso that it is not simultaneously true that p1=p3=1 and p2=0,
where p4, p5, p6 are each 0 or 1, with the proviso that it is not simultaneously true that p4=p6=1 and p5=0,
where q1, q2 are each 0 or 1, where, when q1=0, then q2=0,
where q3=0 or 1,
where q4, q5, q6 are each 0 or 1, with the proviso that it is not simultaneously true that q4=q6=1 and q5=0,
where q7, q8, q9 are each 0 or 1, with the proviso that it is not simultaneously true that q7=q9=1 and q8=0, and that, when q7=1 and q8=0, then q9=0,
where X², X⁵, Y¹, Y⁴, Y⁶, Y⁹ are independently selected from the group consisting of oxygen, sulphur,
where X¹, X³, X⁴, X⁶, Y², Y³, Y⁷, Y¹⁰ are independently selected from the group consisting of O, S, NH, N-alkyl,
where Y⁵, Y⁸ is selected from NH, N-alkyl,
where B⁵, B⁶ are independently selected from the group consisting of
divalent (hetero)aromatic radical,
divalent aliphatic radical optionally substituted by at least one group selected from nitro group, —NH₂, —CN, —SH, —OH, halogen and optionally having at least one group selected from ether, thioether, amino ether, carbonyl group, carboxylic ester group, carboxamide group, sulphonic ester group, phosphoric ester,
and where “&&” for B¹ denotes the bond pointing toward A⁵, for B² the bond pointing toward A⁶, for B³ the bond pointing toward A⁷, and for B⁴ the bond pointing toward A¹³,
and where “&” for B¹ denotes the bond which joins B¹ to the double bond, for B² the bond which joins B² to the double bond, for B³ the bond which joins B³ to the double bond, and for B⁴ the bond which joins B⁴ to the double bond.

3. Polymer according to claim 2 comprising n¹ mutually linked repeat units of the chemical structure (I) or n² mutually linked repeat units of the chemical structure (II) with 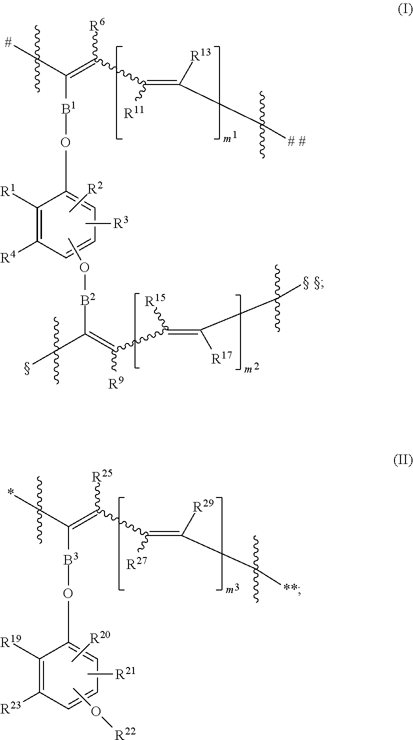
where n¹ and n² are each independently an integer ≧4 and ≦5000,
where m¹, m², m³ are each independently an integer ≧0 and ≦5000,
where the repeat units of the chemical structure (I) within the polymer are the same or at least partly different from one another,
where the repeat units of the chemical structure (II) within the polymer are the same or at least partly different from one another,
where the repeat units of the chemical structure (I) within the polymer are joined to one another in such a way that the bond identified by “# #” in a particular repeat unit is joined by the bond identified by “#” in the adjacent repeat unit and the bond identified by “§§” in a particular repeat unit is joined by the bond identified by “§” in the adjacent repeat unit,
where the repeat units of the chemical structure (II) within the polymer are joined to one another in such a way that the bond identified by “*” in a particular repeat unit is joined by the bond identified by “**” in the adjacent repeat unit,
where the R¹, R², R³, R⁴, R⁶, R⁹, R¹¹, R¹³, R¹⁵, R¹⁷, R¹⁹, R²⁰, R²¹, R²³, R²⁵, R²⁷, R²⁹ radicals are each independently selected from the group consisting of
hydrogen, alkyl group having 1 to 30 carbon atoms,
and where R²² is an alkyl group having 1 to 30 carbon atoms,
and where the R¹¹, R¹³, R¹⁵, R¹⁷ radicals may each independently also be a group of the general structure (III) with 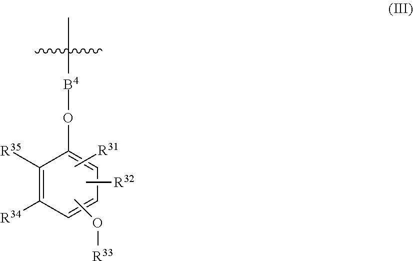
where the R³¹, R³², R³⁴, R³⁵ radicals are each independently selected from the group consisting of hydrogen, alkyl group having 1 to 30 carbon atoms, and where R³³ is an alkyl group having 1 to 30 carbon atoms,
and where the R⁶, R⁹, R¹¹, R¹³, R¹⁵, R¹⁷, R²⁵, R²⁷, R²⁹ radicals may each also be selected from the group consisting of
nitro group, —CN, —F, —Cl, —Br, —I, —O—R⁴⁰ where R⁴⁰ is an alkyl group having 1 to 30 carbon atoms,
where B¹, B², B³, B⁴ are independently selected from the group consisting of direct bond,
&-(X¹)ₚ₁—[C═X²]ₚ₂—(X³)ₚ₃—B⁵—(Y²)_{q2}—[C═Y¹]_{q1}-&&,
&-(Y³)_{q3}—(C═Y⁴)-&&,
where p1, p2, p3 are each 0 or 1, with the proviso that it is not simultaneously true that p1=p3=1 and p2=0,
where q1, q2 are each 0 or 1, where, when q1=0, then q2=0,
where q3=0 or 1,
where X², Y¹, Y⁴ are independently selected from the group consisting of oxygen, sulphur,
where X¹, X³, Y², Y³ are independently selected from the group consisting of O, S,
and where B⁵ is selected from the group consisting of &-phenylene-CH₂-&&, a divalent aliphatic radical optionally having at least one group selected from ether, thioether, amino ether.

4. Polymer according to claim 3 comprising n¹ mutually linked repeat units of the chemical structure (I) or n² mutually linked repeat units of the chemical structure (II) with 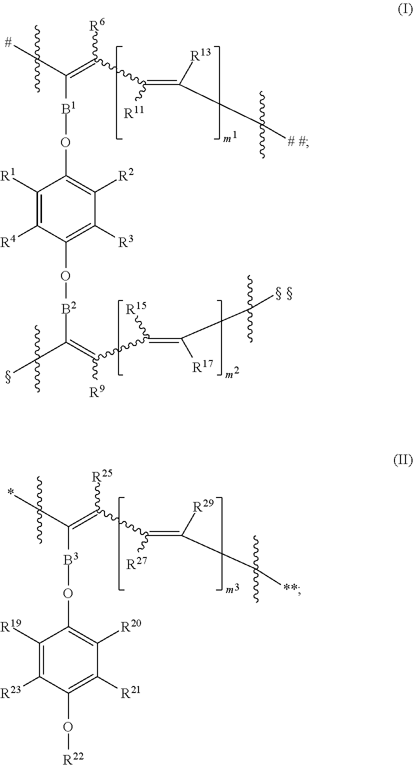
where n¹ and n² are each independently an integer ≧10 and ≦1000,
where m¹, m², m³ are each independently an integer ≧0 and ≦1000,
where the repeat units of the chemical structure (I) within the polymer are the same or at least partly different from one another,
where the repeat units of the chemical structure (II) within the polymer are the same or at least partly different from one another,
where the repeat units of the chemical structure (I) within the polymer are joined to one another in such a way that the bond identified by “# #” in a particular repeat unit is joined by the bond identified by “4” in the adjacent repeat unit and the bond identified by “§§” in a particular repeat unit is joined by the bond identified by “§” in the adjacent repeat unit,
where the repeat units of the chemical structure (II) within the polymer are joined to one another in such a way that the bond identified by “*” in a particular repeat unit is joined by the bond identified by “**” in the adjacent repeat unit,
where the R¹, R², R³, R⁴, R⁶, R⁹, R¹³, R¹⁵, R¹⁷, R¹⁹, R²⁰, R²¹, R²³, R²⁵, R²⁷, R²⁹ radicals are each independently selected from the group consisting of hydrogen, alkyl group having 1 to 8 carbon atoms,
and where R²² is an alkyl group having 1 to 8 carbon atoms,
and where the R¹¹, R¹³, R¹⁵, R¹⁷ radicals may each independently also be a group of the general structure (III) with 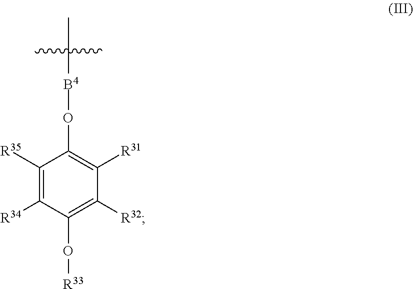
where the R³¹, R³², R³⁴, R³⁵ radicals are each independently selected from the group consisting of hydrogen, alkyl group having 1 to 8 carbon atoms,
and where R³³ is an alkyl group having 1 to 8 carbon atoms,
and where R⁶, R⁹, R¹¹, R¹³, R¹⁵, R¹⁷, R²⁵, R²⁷, R²⁹ may each also be selected from the group consisting of
nitro group, —CN, —F, —Cl, —Br, —I, —O—R⁴⁰ where R⁴⁰ is an alkyl
group having 1 to 8 carbon atoms,
where B¹, B², B³, B⁴ are independently selected from the group consisting of direct bond,
&-(O)ₚ₁—[C═O]ₚ₂—(O)ₚ₃—B⁵-&&,
where p1, p2, p3 are each 0 or 1, with the proviso that it is not simultaneously true that p1=p3=1 and p2=0,
B⁵ is an alkylene group having 1 to 30 carbon atoms.

5. Polymer according to claim 4,
where R¹═R³, R²═R⁴, R¹⁹═R²¹, R²⁰═R²³, R³¹═R³⁴, R³²═R³⁵.

6. Polymer according to claim 5, where R¹═R³═H, R²═R⁴=alkyl group having 1 to 8 carbon atoms, R¹⁹═R²¹═H, R²⁰═R²³=alkyl group having 1 to 8 carbon atoms, R³¹═R³⁴═H, R³²═R³⁵=alkyl group having 1 to 8 carbon atoms and B¹, B², B³, B⁴ are each independently selected from the group consisting of direct bond, methylene, ethylene, n-propylene, &-B⁵—CH₂-&& where B⁵=1,4-phenylene.

7. Polymer according to claim 6, where R¹═R³═H, R²═R⁴=alkyl group having 1 to 6 carbon atoms, R¹⁹═R²¹═H, R²⁰═R²³=alkyl group having 1 to 6 carbon atoms, R³¹═R³⁴═H, R³²═R³⁵=alkyl group having 1 to 6 carbon atoms.

8. Polymer according to claim 7, where R¹═R³═H, R²═R⁴=tert-butyl group, R¹⁹═R²¹═H, R²⁰═R²³=tort-butyl group, R³¹═R³⁴═H, R³²═R³⁵=tert-butyl group.

9. Use of the polymers according to claim 1 as redox-active electrode material for electrical charge storage means.

10. Use of the polymers according to claim 1 in an electrode slurry for electrical charge storage means.
